(19) United States
(12) Patent Application Publication
(10) Pub. No.: US 2024/0259768 A1
(43) Pub. Date: Aug. 1, 2024

(54) Support for Localized Multimedia Broadcast/Multicast Service in Edge Computing System

(71) Applicant: Telefonaktiebolaget LM Ericsson (publ), Stockholm (SE)

(72) Inventors: Fengpei Zhang, Guangzhou, Guangdong (CN); Jing Su, Guangzhou, Guangdong (CN)

(21) Appl. No.: 18/561,224

(22) PCT Filed: Jun. 3, 2021
(86) PCT No.: PCT/CN2021/098141

§ 371 Date: Nov. 15, 2023

(51) Int. Cl. H04W 4/06

(52) U.S. Cl. CPC H04W 4/06

(57) ABSTRACT

The present disclosure is related to methods and network nodes for supporting localized multimediabroadcast/multicast service (MBMS) in an edge computing system. A method at an edge orchestrator in an edge computing system for supporting localized MBMS comprises: receiving, from an application server on which a central application is hosted, a first request for performing an MBMS service management procedure for the central application; processing the first request; and transmitting, to the application server, a first response indicating whether the MBMS service management procedure is successfully performed or not at least partially based on a result of the processing.

### TECHNICAL FIELD

The present disclosure is related to the field of telecommunications, and in particular, to methods and network nodes for supporting localized multimedia broadcast/multicast service (MBMS) in an edge computing (EC) system.

### BACKGROUND

Edge computing as an evolution of cloud computing brings application hosting from centralized data centers down to the network edge, closer to consumers and the data generated by applications. Edge computing is acknowledged as one of the key pillars for meeting the demanding Key Performance Indicators (KPIs) of 5G, especially as far as low latency and bandwidth efficiency are concerned. However, not only is edge computing in telecommunications networks a technical enabler for the demanding KPIs, it also plays an essential role in the transformation of the telecommunications business, where telecommunications networks are turning into versatile service platforms for industry and other specific customer segments. This transformation is supported by edge computing, as it opens the network edge for applications and services, including those from third parties.

European Telecommunications Standards Institution (ETSI) Industry Specification Group (ISG) MEC (Multi-access Edge Computing) is the home of technical standards for edge computing. The group has already published a set of specifications (Phase 1) focusing on management and orchestration (MANO) of MEC applications, application enablement API, service Application Programming Interfaces (APIs) and the User Equipment (UE) application API. The MANO and application enablement functions contribute to enabling service environments in edge data centers, while the service APIs enable the exposure of underlying network information and capabilities to applications. One of the key value-adding features of the MEC specification is this ability for applications to gain contextual information and real-time awareness of their local environment through these standardized APIs. This local services environment is a flexible and extendable framework, as new services can be introduced, for example, by Third Generation Partnership Project (3GPP), when creating new service APIs. And finally, the UE application API lets the client application in the UE interact with the MEC system for application lifecycle management.

Multimedia Broadcast Multicast Services (MBMS) is a point-to-multipoint interface specification for existing 3GPP cellular networks, which is designed to provide efficient delivery of broadcast and multicast services, both within a cell as well as within the core network. For broadcast transmission across multiple cells, it defines transmission via single-frequency network configurations. The specification is referred to as Evolved Multimedia Broadcast Multicast Services (eMBMS) when transmissions are delivered through an LTE (Long Term Evolution) network. eMBMS is also known as LTE Broadcast. Target applications include mobile TV and radio broadcasting, live streaming video services, as well as file delivery and emergency alerts.

The MBMS feature is split into the MBMS Bearer Service and the MBMS User Service and has been defined to be offered over both UTRAN (i.e. WCDMA, TD-CDMA and TD-SCDMA) and LTE (where it is often referred to as eMBMS). The MBMS Bearer Service includes a Unicast and a Broadcast Mode. MBMS Operation On-Demand (MOOD) allows dynamic switching between Unicast and Broadcast over LTE, based on configured triggers. The MBMS Bearer Service uses IP multicast addresses for the IP flows. The advantage of the MBMS Bearer Service compared to unicast bearer services (interactive, streaming, etc.) is that the transmission resources in the core and radio networks are shared. One MBMS packet flow is replicated by GGSN, SGSN and RNCs. MBMS may use an advanced counting scheme to decide, whether or not zero, one or more dedicated (i.e. unicast) radio channels lead to a more efficient system usage than one common (i.e. broadcast) radio channel. However, MBMS and eMBMS are not specifically optimized for an edge computing environment, and therefore support for MBMS in an edge computing system is needed.

### SUMMARY

According to a first aspect of the present disclosure, a method at an edge orchestrator in an edge computing system for supporting localized Multimedia Broadcast/Multicast Service (MBMS) is provided. The method comprises that a first request for performing an MBMS service management procedure for a central application is received from an application server on which the central application is hosted. The method further comprises that the first request is processed. The method further comprises that a first response indicating whether the MBMS service management procedure is successfully performed or not is transmitted to the application server at least partially based on a result of the processing.

In some embodiments, before the step of receiving the first request, the method further comprises transmitting, to each of one or more edge nodes on which an MBMS support service is hosted, a second request for provisioning a configuration at the corresponding edge node for localized MBMS, and the method further comprises receiving, from each of the one or more edge nodes, a second response indicating whether the configuration is successfully provisioned at the corresponding edge node or not. In some embodiments, each of the configurations is an edge-node-specific configuration. In some embodiments, each of the configurations is a configuration for MBMS that is local to a serving area of the corresponding edge node. In some embodiments, the MBMS service management procedure is an MBMS user service creation procedure when the xMB interface is used, and the MBMS service management procedure is a temporary mobile group identity (TMGI) allocation procedure when the MB2 interface is used.

In some embodiments, when the xMB interface is used, the first request is a request for creating an MBMS user service and comprises at least one of an identifier of the central application and a service name of the MBMS user service, and the first response comprises at least one of an identifier of resource assigned to the MBMS user service, a service identifier assigned to the MBMS user service, and the service name of the MBMS user service. In some embodiments, the step of processing the first request comprises transmitting, to a Broadcast Multicast Service Center (BM-SC) via the xMB interface, a third request for creating the MBMS user service for the central application at least partially based on the first request, and the method further comprises receiving, from the BM-SC via the xMB interface, a third response indicating whether the MBMS user service is successfully created or not. In some embodiments, the third request comprises the service name of the MBMS user service, and the third response comprises at least one of an identifier of resource assigned to the MBMS user service, a service identifier assigned to the MBMS user service, and the service name of the MBMS user service.

In some embodiments, the method further comprises determining at least one edge node from the one or more edge nodes at least partially based on serving areas of the one or more edge nodes, and the method further comprises transmitting, to each of the at least one edge node, a fourth request for notifying information for the MBMS user service. In some embodiments, the method further comprises receiving, from each of the at least one edge node, a fourth response acknowledging the fourth request. In some embodiments, the fourth request comprises at least one of an identifier of the central application, the identifier of resource assigned to the MBMS user service, the service identifier assigned to the MBMS user service, and the service name of the MBMS user service.

In some embodiments, when the MB2 interface is used, the first request is a request for allocating a TMGI from localized MBMS and comprises an identifier of the central application, and the first response comprises at least one of the TMGI and an expiration time corresponding to the duration for the TMGI. In some embodiments, the step of processing the first request comprises transmitting, to a Broadcast Multicast Service Center (BM-SC) via the MB2 interface, a third request for allocating the TMGI at least partially based on the first request, and comprises receiving, from the BM-SC via the MB2 interface, a third response indicating whether the TMGI is successfully allocated or not. In some embodiments, the third response comprises at least one of an allocated TMGI and a duration for the allocated TMGI.

In some embodiments, the method further comprises determining at least one edge node from the one or more edge nodes at least partially based on serving areas of the one or more edge nodes, and the method further comprises transmitting, to each of the at least one edge node, a fourth request for notifying the allocated TMGI, and the method further comprises receiving, from each of the at least one edge node, a fourth response acknowledging the fourth request. In some embodiments, the fourth request comprises at least one of an identifier of the central application and the allocated TMGI. In some embodiments, the step of processing the first request further comprises authenticating the application server for the first request. In some embodiments, the step of transmitting, to the application server, a first response comprises transmitting, to the application server, a first response indicating that the MBMS service management procedure is not successfully performed in response to determining that the application server is not successfully authenticated, or comprises transmitting, to the application server, a first response indicating that the MBMS service management procedure is successfully performed at least partially based on determining that the application server is successfully authenticated.

According to a second aspect of the present disclosure, an edge orchestrator in an edge computing system is provided. The edge orchestrator comprises a processor and a memory storing instructions which, when executed by the processor, cause the processor to perform the method of any of the first aspect.

According to a third aspect of the present disclosure, a method at an edge node, on which a Multimedia Broadcast/Multicast Service (MBMS) support service is hosted, in an edge computing system for supporting localized MBMS is provided. The method comprises that a fifth request for performing an MBMS session management procedure is received from an edge node on which an edge application is hosted. The method further comprises that the fifth request is processed. The method further comprises a fifth response indicating whether the MBMS session management procedure is successfully performed or not is transmitted to the edge node on which the edge application is hosted at least partially based on a result of the processing.

In some embodiments, before the step of receiving the fifth request, the method further comprises receiving, from an edge orchestrator, a second request for provisioning a configuration for localized MBMS. The method further comprises provisioning the configuration, and further comprises transmitting, to the edge orchestrator, a second response indicating whether the configuration is successfully provisioned or not at least partially based on a result of the provisioning. In some embodiments, the configuration is an edge-node-specific configuration. In some embodiments, the configuration is a configuration for MBMS that is local to a serving area of the edge node on which the MBMS support service is hosted. In some embodiments, the MBMS session management procedure is an MBMS session creation procedure when the xMB interface is used, and the MBMS session management procedure is an MBMS bearer activation procedure when the MB2 interface is used.

In some embodiments, when the xMB interface is used, the fifth request is a request for creating an MBMS session and comprises at least one of an identifier of resource assigned to an MBMS user service, a session start time, a session stop time, and an indicator indicating a location area, and the fifth response comprises at least one of an identifier of resource assigned to the MBMS session and information for one or more user plane entities. In some embodiments, the step of processing the fifth request comprises determining one or more localized MBMS gateways (GWs) for creating the MBMS session at least partially based on the configuration for localized MBMS, serving areas of the one or more localized MBMS GWs, and/or the location area, further comprises transmitting, to each of BM-SCs associated with the one or more localized MBMS GWs, a sixth request for creating the MBMS session, and further comprises receiving, from each of the BM-SCs, a sixth response indicating whether the MBMS session is successfully created or not. In some embodiments, the sixth request comprises at least one of the identifier of resource assigned to the MBMS user service, the session start time, the session stop time, and information for the one or more localized MBMS GWs, and the sixth response comprises at least one of the identifier of resource assigned to the MBMS session and the information for one or more user plane entities.

In some embodiments, before the step of receiving the fifth request, the method further comprises receiving, from the edge orchestrator, a fourth request for notifying information for the MBMS user service. The method further comprises processing the information for the MBMS user service, and further comprises transmitting, to the edge orchestrator, a fourth response acknowledging the fourth request. In some embodiments, the fourth request comprises at least one of an identifier of a central application associated with the edge application, an identifier of resource assigned to the MBMS user service, a service identifier assigned to the MBMS user service, and a service name of the MBMS user service.

In some embodiments, after the step of transmitting the fourth response and before the step of receiving the fifth request, the method further comprises receiving, from the edge node on which the edge application is hosted, a seventh request for subscribing an MBMS user service change notification. The method further comprises transmitting, to the edge node on which the edge application is hosted, a seventh response indicating whether the MBMS user service change notification is successfully subscribed or not. The method further comprises in response to determining that the seventh response indicates that the MBMS user service change notification is successfully subscribed, transmitting, to the edge node on which the edge application is hosted, an eighth request for notifying a change in the MBMS user service. The method further comprises receiving, from the edge node on which the edge application is hosted, an eighth response for acknowledging the eighth request. In some embodiments, the seventh request comprises at least an identifier of the central application, and the eighth request comprises at least one of an identifier of resource assigned to the MBMS user service, a service identifier assigned to the MBMS user service, and the service name of the MBMS user service.

In some embodiments, when the MB2 interface is used, the fifth request is a request for activating an MBMS bearer and comprises at least one of a temporary mobile group identity (TMGI) and an indicator indicating a location area, and the fifth response comprises at least one of the TMGI, an assigned flow identifier, and information for one or more user plane entities. In some embodiments, the step of processing the fifth request comprises determining one or more localized MBMS gateways (GWs) for activating the MBMS bearer at least partially based on the configuration for localized MBMS, serving areas of the one or more localized MBMS GWs, and/or the location area, further comprises transmitting, to each of BM-SCs associated with the one or more localized MBMS GWs, a sixth request for activating the MBMS bearer, and further comprises receiving, from each of the BM-SCs, a sixth response indicating whether the MBMS bearer is successfully activated or not. In some embodiments, the sixth request comprises at least one of the TMGI and information for the one or more localized MBMS GWs, and the sixth response comprises at least one of the TMGI, the assigned flow identifier, a duration of the session associated with the flow, and information for one or more user plane entities.

In some embodiments, before the step of receiving the fifth request, the method further comprises receiving, from the edge orchestrator, a fourth request for notifying the TMGI and the identifier of the central application. The method further comprises storing the TMGI and the identifier of the central application in an associated manner, and further comprises transmitting, to the edge orchestrator, a fourth response acknowledging the fourth request. In some embodiments, after the step of transmitting the fourth response and before the step of receiving the fifth request, the method further comprises receiving, from the edge node on which the edge application is hosted, a seventh request for subscribing a TMGI change notification. The method further comprises transmitting, to the edge node on which the edge application is hosted, a seventh response indicating whether the TMGI change notification is successfully subscribed or not, wherein the method further comprises in response to determining that the seventh response indicates that the TMGI change notification is successfully subscribed, transmitting, to the edge node on which the edge application is hosted, an eighth request for notifying a change of the TMGI, and further comprises receiving, from the edge node on which the edge application is hosted, an eighth response for acknowledging the eighth request. In some embodiments, the seventh request comprises at least an identifier of the central application, and the eighth request comprises the latest TMGI associated with the central application. In some embodiments, the method further comprises: forwarding a message from a user equipment (UE) via the edge application to the BM-SC for multicasting or broadcasting.

According to a fourth aspect of the present disclosure, an edge node, on which an MBMS support service is hosted, in an edge computing system is provided. The edge node comprises a processor and a memory storing instructions which, when executed by the processor, cause the processor to perform the method of any of the third aspect.

According to a fifth aspect of the present disclosure, a method at an edge node, on which an edge application is hosted, in an edge computing system for supporting localized MBMS is provided. The method comprises that a fifth request for performing an MBMS session management procedure is transmitted to an edge node on which an MBMS support service is hosted. The method further comprises that a fifth response indicating whether the MBMS session management procedure is successfully performed or not received from the edge node on which the MBMS support service is hosted.

In some embodiments, the MBMS session management procedure is an MBMS session creation procedure when the xMB interface is used, and the MBMS session management procedure is an MBMS bearer activation procedure when the MB2 interface is used.

In some embodiments, when the xMB interface is used, the fifth request is a request for creating an MBMS session and comprises at least one of an identifier of resource assigned to an MBMS user service, a session start time, a session stop time, and an indicator indicating a location area, and the fifth response comprises at least one of an identifier of resource assigned to the MBMS session and information for one or more user plane entities. In some embodiments, before the step of transmitting the fifth request, the method further comprises transmitting, to the edge node on which the MBMS support service is hosted, a seventh request for subscribing an MBMS user service change notification. The method further comprises receiving, from the edge node on which the MBMS support service is hosted, a seventh response indicating whether the MBMS user service change notification is successfully subscribed or not, wherein the method further comprises in response to determining that the seventh response indicates that the MBMS user service change notification is successfully subscribed, receiving, from the edge node on which the MBMS support service is hosted, an eighth request for notifying a change in the MBMS user service, and further comprises transmitting, to the edge node on which the MBMS support service is hosted, an eighth response for acknowledging the eighth request. In some embodiments, the seventh request comprises at least an identifier of the central application, and the eighth request comprises at least one of an identifier of resource assigned to the MBMS user service, a service identifier assigned to the MBMS user service, and the service name of the MBMS user service.

In some embodiments, when the MB2 interface is used, the fifth request is a request for activating an MBMS bearer and comprises at least one of a temporary mobile group identity (TMGI) and an indicator indicating a location area, and the fifth response comprises at least one of the TMGI, an assigned flow identifier, and information for one or more user plane entities. In some embodiments, before the step of transmitting the fifth request, the method further comprises transmitting, to the edge node on which the MBMS support service is hosted, a seventh request for subscribing a TMGI change notification. The method further comprises receiving, from the edge node on which the MBMS support service is hosted, a seventh response indicating whether the TMGI change notification is successfully subscribed or not, wherein the method further comprises in response to determining that the seventh response indicates that the TMGI change notification is successfully subscribed, receiving, from the edge node on which the MBMS support service is hosted, an eighth request for notifying a change of the TMGI, and further comprises transmitting, to the edge node on which the MBMS support service is hosted, an eighth response for acknowledging the eighth request. In some embodiments, the seventh request comprises at least an identifier of the central application, and the eighth request comprises the latest TMGI associated with the central application. In some embodiments, the method further comprises: forwarding a message from a user equipment (UE) to the edge node, on which the MBMS support service is hosted, for multicasting or broadcasting.

According to a sixth aspect of the present disclosure, an edge node, on which an edge application is hosted, in an edge computing system is provided. The edge node comprises a processor and a memory storing instructions which, when executed by the processor, cause the processor to perform the method of any of the fifth aspect.

According to a seventh aspect of the present disclosure, a method at an application server, on which a central application is hosted, for supporting localized Multimedia Broadcast/Multicast Service (MBMS) is provided. The method comprises that a first request for performing an MBMS service management procedure for the central application is transmitted to an edge orchestrator. The method further comprises that a first response indicating whether the MBMS service management procedure is successfully performed or not is received from the edge orchestrator.

In some embodiments, the MBMS service management procedure is an MBMS user service creation procedure when the xMB interface is used, and the MBMS service management procedure is a temporary mobile group identity (TMGI) allocation procedure when the MB2 interface is used. In some embodiments, when the xMB interface is used, the first request is a request for creating an MBMS user service and comprises at least one of an identifier of the central application and a service name of the MBMS user service, and the first response comprises at least one of an identifier of resource assigned to the MBMS user service, a service identifier assigned to the MBMS user service, and the service name of the MBMS user service. In some embodiments, when the MB2 interface is used, the first request is a request for allocating a TMGI from localized MBMS and comprises an identifier of the central application, and the first response comprises at least one of the TMGI and an expiration time corresponding to the duration for the TMGI.

According to an eighth aspect of the present disclosure, an application server is provided. The application server comprises a processor and a memory storing instructions which, when executed by the processor, cause the processor to perform the method of any of the seventh aspect.

According to a ninth aspect of the present disclosure, a method at a BM-SC in a localized Multimedia Broadcast/Multicast Service (MBMS) system for supporting an edge computing system is provided. The method comprises that a sixth request for performing an MBMS session management procedure is received from an edge node on which an MBMS support service is hosted. The method further comprises that the MBMS session management procedure is performed. The method further comprises that a sixth response indicating whether the MBMS session management procedure is successfully performed or not is transmitted to the edge node at least partially based on a result of performing the MBMS session management procedure.

In some embodiments, before the step of receiving the sixth request, the method further comprises receiving, from an edge orchestrator, a third request for performing an MBMS service management procedure for a central application. The method further comprises performing the MBMS service management procedure. The method further comprises transmitting, to the edge orchestrator, a third response indicating whether the MBMS service management procedure is successfully performed or not at least partially based on a result of performing the MBMS service management procedure. In some embodiments, the MBMS session management procedure is an MBMS session creation procedure and the MBMS service management procedure is an MBMS user service creation procedure when the xMB interface is used, and the MBMS session management procedure is an MBMS bearer activation procedure and the MBMS service management procedure is a temporary mobile group identity (TMGI) allocation procedure when the MB2 interface is used.

In some embodiments, when the xMB interface is used, the third request comprises a service name of an MBMS user service, and the third response comprises at least one of an identifier of resource assigned to the MBMS user service, a service identifier assigned to the MBMS user service, and the service name of the MBMS user service, wherein when the xMB interface is used, the sixth request comprises at least one of an identifier of resource assigned to the MBMS user service, a session start time, a session stop time, and information for one or more localized MBMS GWs associated with the BM-SC, and the sixth response comprises at least one of an identifier of resource assigned to the MBMS session and information for one or more user plane entities.

In some embodiments, when the MB2 interface is used, the third response comprises at least one of an allocated TMGI and a duration for the allocated TMGI, wherein when the MB2 interface is used, the sixth request comprises at least one of the TMGI and information for the one or more localized MBMS GWs, and the sixth response comprises at least one of the TMGI, the assigned flow identifier, a duration of the session associated with the flow, and information for one or more user plane entities. In some embodiments, the method further comprises transmitting, to the one or more localized MBMS GWs, one or more ninth requests for starting an MBMS session, respectively. The method further comprises receiving, from the one or more localized MBMS GWs, one or more ninth responses indicating whether a MBMS session is started or not, respectively. In some embodiments, the method further comprises: forwarding a message from the edge node, on which an MBMS support service is hosted, to at least one of the one or more localized MBMS GWs for multicasting or broadcasting.

According to a tenth aspect of the present disclosure, a BM-SC in a localized MBMS system is provided. The BM-SC comprises a processor and a memory storing instructions which, when executed by the processor, cause the processor to perform the method of any of the ninth aspect.

According to an eleventh aspect of the present disclosure, a computer program including instructions is provided. The instructions, when executed by at least one processor, cause the at least one processor to carry out any of the methods of any of the first, third, fifth, seventh, and ninth aspects.

According to an twelfth aspect of the present disclosure, a carrier containing the computer program of the eleventh aspect is provided. In some embodiments, the carrier is one of an electronic signal, optical signal, radio signal, or computer readable storage medium.

According to a thirteenth aspect of the present disclosure, an edge computing system for supporting localized Multimedia Broadcast/Multicast Service (MBMS) is provided. The edge computing system comprises an edge orchestrator of the second aspect and one or more edge nodes of the fourth and/or sixth aspects.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary edge computing system in which localized MBMS may be applicable according to an embodiment of the present disclosure.

FIG. 2 is a diagram illustrating an exemplary implementation of the edge computing system shown in FIG. 1.

FIG. 3 is a diagram illustrating an exemplary reference architecture in which MBMS is applicable according to an embodiment of the present disclosure.

FIG. 4A and FIG. 4B are diagrams illustrating exemplary localized MBMS architectures which are applicable in an edge computing system according to an embodiment of the present disclosure.

FIG. 5A and FIG. 5B are diagrams illustrating exemplary reference points between a Broadcast Multicast-Service Center (BM-SC) and an application server that may be applicable in an edge computing system according to an embodiment of the present disclosure.

FIG. 6 is a diagram illustrating an exemplary edge computing system in which localized MBMS is supported according to an embodiment of the present disclosure.

FIG. 7 is a diagram illustrating an exemplary procedure for supporting localized MBMS in the edge computing system shown in FIG. 6 according to an embodiment of the present disclosure.

FIG. 8 is a diagram illustrating an exemplary improved edge computing system in which localized MBMS may be applicable according to another embodiment of the present disclosure.

FIG. 9 is a diagram illustrating an exemplary improved implementation of the edge computing system shown in FIG. 8.

FIG. 10 is a diagram illustrating an exemplary procedure for provisioning configuration for localized MBMS in an edge computing system according to an embodiment of the present disclosure.

FIG. 11 to FIG. 14 are diagrams illustrating exemplary procedures for supporting localized MBMS in an edge computing system via the xMB interface according to an embodiment of the present disclosure.

FIG. 15 to FIG. 18 are diagrams illustrating exemplary procedures for supporting localized MBMS in an edge computing system via the MB2 interface according to an embodiment of the present disclosure.

FIG. 19 is a flow chart of an exemplary method at an edge orchestrator in an edge computing system for supporting localized MBMS according to an embodiment of the present disclosure.

FIG. 20 is a flow chart of an exemplary method at an edge node, on which an MBMS support service is hosted, in an edge computing system for supporting localized MBMS according to an embodiment of the present disclosure.

FIG. 21 is a flow chart of an exemplary method at an edge node, on which an edge application is hosted, in an edge computing system for supporting localized MBMS according to an embodiment of the present disclosure.

FIG. 22 is a flow chart of an exemplary method at an application server, on which a central application is hosted, in an edge computing system for supporting localized MBMS according to an embodiment of the present disclosure.

FIG. 23 is a flow chart of an exemplary method at a BM-SC in a localized Multimedia Broadcast/Multicast Service (MBMS) system for supporting an edge computing system according to an embodiment of the present disclosure.

FIG. 24 schematically shows an embodiment of an arrangement which may be used in an edge orchestrator, an edge node, an application server, and/or a BM-SC according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of Long Term Evolution (LTE), the present disclosure is not limited thereto. In fact, as long as support for localized MBMS in an edge computing system is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 5G New Radio (5G NR), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, or any other equivalents. Further, the term “node” used herein may refer to a UE, a functional entity, a network entity, a network element, a network equipment, or any other equivalents.

Further, following ETSI documents are incorporated herein by reference in their entireties:
ETSI GS MEC 003 V2.1.1 (2019 January), Multi-access Edge Computing (MEC); Framework and Reference Architecture;
3GPP TS 23.246 V16.1.0 (2019 September), 3rd Generation Partnership Project; Technical Specification Group Services and System Aspects; Multimedia Broadcast/Multicast Service (MBMS); Architecture and functional description (Release 16);
3GPP TS 23.285 V16.4.0 (2020 September), 3rd Generation Partnership Project; Technical Specification Group Services and System Aspects; Architecture enhancements for V2X services (Release 16); and
3GPP TS 26.348 V16.3.0 (2020 March), 3rd Generation Partnership Project; Technical Specification Group Services and System Aspects; Northbound Application Programming Interface (API) for Multimedia Broadcast/Multicast Service (MBMS) at the xMB reference point (Release 16).

As mentioned above, edge computing as an evolution of cloud computing brings application hosting from centralized data centers down to the network edge, closer to consumers and the data generated by applications, especially when latency and bandwidth efficiency are concerned.

Edge computing plays an essential role in the transformation of the telecommunications business, where telecommunications networks are turning into versatile service platforms for industry and other specific customer segments. This transformation is supported by edge computing, as it opens the network edge for applications and services, including those from third parties.

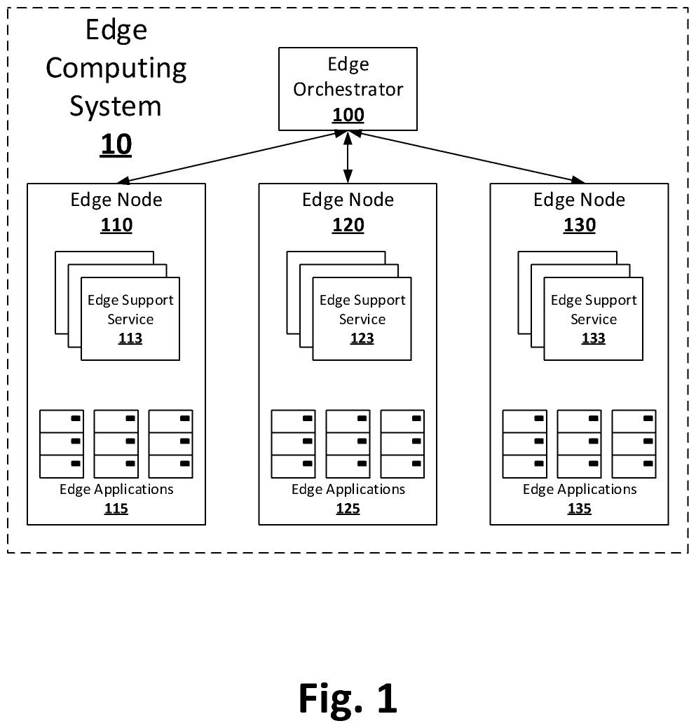

FIG. 1 is a diagram illustrating an exemplary edge computing system 10 in which localized MBMS may be applicable according to an embodiment of the present disclosure. As shown in FIG. 1, the edge computing system 10 may typically comprise an edge orchestrator 100 in system level and multiple edge nodes 110, 120, and 130 that host one or more edge applications 115, 125, and/or 135, respectively.

In some embodiments, the edge orchestrator 100 may handle the interaction with external systems (e.g., an MBMS system), and coordinate edge nodes 110, 120, and 130. In some embodiments, each of the edge nodes 110, 120, and 130 may provide a virtualized infrastructure to host one or more edge applications 115, 125, and/or 135 and offer multiple built-in edge support services 113, 123, and/or 133 to facilitate the edge applications 115, 125, and/or 135 in the edge computing system 10. In some embodiments, the edge applications 115, 125, and 135 may be different instances of a same edge application running at different edge nodes.

In some embodiments, different edge nodes 110, 120, and/or 130 may serve UEs located in different area. For example, the edge node 110 located in Beijing may serve UEs located in Beijing, the edge node 120 located in Hebei Province may serve UEs located in Hebei Province, and the edge node 130 located in Tianjin may serve UEs located in Tianjin. In such a case, a UE that is moving from Beijing to Tianjin may be served by the edge application 115 running at the edge node 110 at first, and then it may be served by the edge application 135 running at the edge node 130 after an edge node switching, such that a better network performance (e.g., a lower latency, a higher throughput, etc.) for the UE may be achieved by a closer serving edge node.

Although three edge nodes 110, 120, and 130 are shown in FIG. 1, the present disclosure is not limited thereto. In some other embodiments, any appropriate number of edge nodes may be deployed in the edge computing system 10.

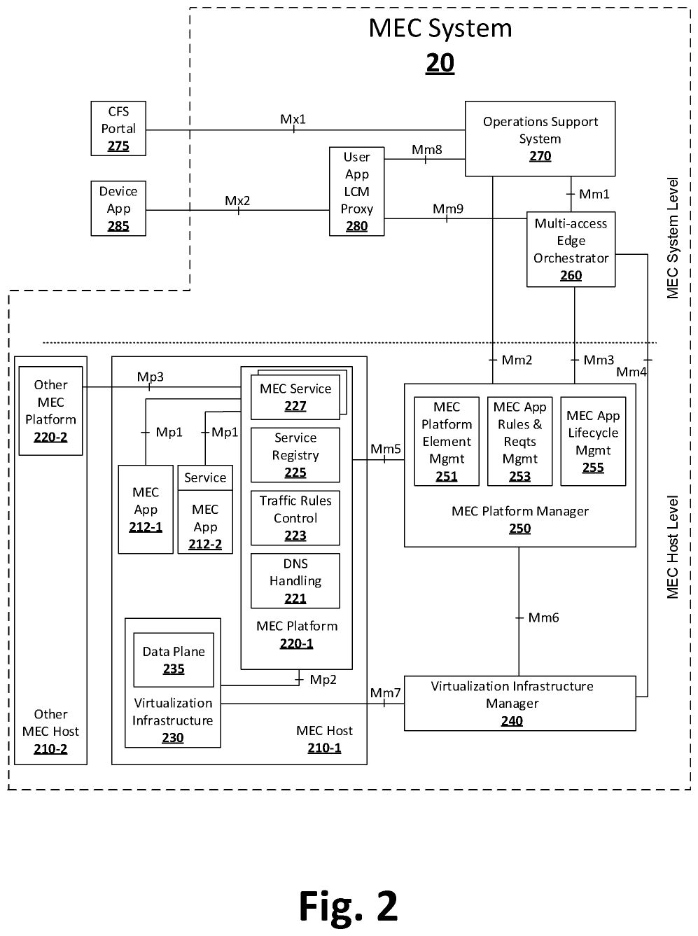

FIG. 2 is a diagram illustrating an exemplary implementation 20 of the edge computing system shown in FIG. 1. As mentioned above, ETSI MEC is a technical standard for edge computing. The working group has already published a set of specifications focusing on management and orchestration of edge applications, application enablement APIs, service Application APIs and the User Equipment (UE) application API.

FIG. 2 shows functional elements and reference points of a MEC system 20. There are three groups of reference points defined between the elements:
reference points regarding the MEC platform functionality (Mp);
management reference points (Mm); and
reference points connecting to external entities (Mx).

The MEC system 20 may consist of the MEC hosts 210-1 and/or 210-2 (hereinafter, referred to as 210 collectively, also known as edge nodes as shown in FIG. 1), and the MEC management necessary to run MEC applications 212-1 and/or 212-2 (hereinafter, referred to as 212 collectively, also known as edge applications as shown in FIG. 1) within an operator network or a subset of an operator network. The MEC host 210-1 is an entity that contains a MEC platform 220-1 and a virtualization infrastructure 230 which provides compute, storage, and network resources, for the purpose of running MEC applications 212-1 or 212-2. The MEC platform 220-1 is the collection of essential functionalities required to run MEC applications 212 on a particular virtualization infrastructure 230 and enable them to provide and consume MEC services (e.g. the service provided by the MEC application 212-2, also known as edge support services as shown in FIG. 1). The MEC platform 220-1 can also provide services 227. MEC applications 212 are instantiated on the virtualization infrastructure 230 of the MEC host 210-1 based on configuration or requests validated by the MEC management. Please note that, although FIG. 2 shows only two MEC hosts 210-1 and 210-2, the present disclosure is not limited thereto. In some other embodiments, more than two MEC hosts may be present in the MEC system.

The MEC management comprises the MEC system level management and the MEC host level management. The MEC system level management includes the multi-access edge orchestrator (MEO, also known as edge orchestrator as shown in FIG. 1) 260 as its core component, which has an overview of the complete MEC system. The MEC host level management comprises the MEC platform manager 250 and the virtualization infrastructure manager 240, and handles the management of the MEC specific functionality of a particular MEC host (e.g. the MEC host 210-1) and the applications 212 running on it.

As shown in FIG. 2, the MEC host 210-1 is an entity that contains the MEC platform 220-1 and the virtualization infrastructure 230 which provides compute, storage, and network resources for the MEC applications 212. The virtualization infrastructure 230 includes a data plane 235 that executes the traffic rules received by the MEC platform 220-1, and routes the traffic among applications 212, services (e.g. the service provided by the MEC application 212-2 or the MEC services 227, or services from other MEC hosts), DNS server/proxy, 3GPP network, other access networks, local networks and external networks.

The MEC platform 220-1 may be responsible for the following functions:
offering an environment where the MEC applications 212 can discover, advertise, consume and offer MEC services, including, when supported, MEC services available via other platforms (that may be in the same or a different MEC system), for example, at least partially through the service registry 225;
receiving traffic rules from the MEC platform manager 250, applications 212, or services, and instructing the data plane 235 accordingly, for example, through the traffic rules control 223. When supported, this includes the translation of tokens representing UEs in the traffic rules into specific IP addresses;
receiving DNS records from the MEC platform manager 250 and configuring a DNS proxy/server accordingly, for example, through the DNS handling 221;
hosting MEC services 227; and/or
providing access to persistent storage and time of day information.

The MEC applications 212 are running as virtual machines (VM) on top of the virtualization infrastructure 230 provided by the MEC host 210-1, and can interact with the MEC platform 220-1 to consume and provide MEC services.

In certain cases, the MEC applications 212 can also interact with the MEC platform 220-1 to perform certain support procedures related to the lifecycle of the application 212, such as indicating availability, preparing relocation of user state, etc.

The MEC applications 212 can have a certain number of rules and requirements associated to them, such as required resources, maximum latency, required or useful services, etc. These requirements are validated by the MEC system level management, and can be assigned to default values if missing.

As shown in FIG. 2, the MEO 260 is the core functionality in MEC system level management. The MEO 260 may be responsible for the following functions:
maintaining an overall view of the MEC system based on deployed MEC hosts, available resources, available MEC services, and topology;
on-boarding of application packages, including checking the integrity and authenticity of the packages, validating application rules and requirements and if necessary adjusting them to comply with operator policies, keeping a record of on-boarded packages, and preparing the virtualization infrastructure manager(s) to handle the applications;
selecting appropriate MEC host(s) for application instantiation based on constraints, such as latency, available resources, and available services;
triggering application instantiation and termination; and/or
triggering application relocation as needed when supported.

The Operations Support System (OSS) 270 shown in FIG. 2 may refer to the OSS of an operator. It may receive requests from the Customer Facing Service (CFS) portal 275 and/or device applications 285 for instantiation or termination of applications, and it may decide on the granting of these requests. Granted requests may be forwarded to the MEO 260 for further processing. When supported, the OSS 270 may also receive requests from device applications for relocating applications between external clouds and the MEC system.

A user application (e.g. the MEC application 212-1 or 212-2) may be a MEC application that is instantiated in the MEC system 20 in response to a request of a user via an application running in the device (for example, the device application 285). The user application lifecycle management (LCM) proxy 280 may allow the device application 285 to request on-boarding, instantiation, termination of user applications 212 and when supported, relocation of user applications 212 in and out of the MEC system. It also allows informing the device application 285 about the state of the user applications 212.

The user application lifecycle management proxy 280 may authorize requests from the device application 285 in the device (e.g. UE, laptop with internet connectivity) and interact with the OSS 270 and the MEO 260 for further processing of these requests. The user application lifecycle management proxy 280 may be only available when supported by the MEC system.

As shown in FIG. 2, the MEC platform manager 250 may be responsible for the following functions:
managing the life cycle of applications including informing the MEO 260 of relevant application related events, for example, through the MEC application lifecycle management 255;
providing element management functions to the MEC platform 220, for example, through the MEC platform element management 251; and/or
managing the application rules and requirements including service authorizations, traffic rules, DNS configuration and resolving conflicts, for example, through the MEC application Rules & Requirements management 253.

The MEC platform manager 250 may also receive virtualized resources fault reports and performance measurements from the virtualization infrastructure manager 240 for further processing.

The virtualization infrastructure manager 240 may be responsible for the following functions:
allocating, managing, and releasing virtualized (compute, storage, and networking) resources of the virtualization infrastructure 230;
preparing the virtualization infrastructure 230 to run a software image. The preparation includes configuring the infrastructure 230, and can include receiving and storing the software image;
when supported, rapid provisioning of applications 212;
collecting and reporting performance and fault information about the virtualized resources; and/or
when supported, performing application relocation. For application relocation from/to external cloud environments, the virtualization infrastructure manager 240 interacts with the external cloud manager to perform the application relocation.

The CFS portal 275 may allow operators' third-party customers (e.g. commercial enterprises) to select and order a set of MEC applications 212 that meet their particular needs, and to receive back service level information from the provisioned applications 212.

Below please find some reference points related to the MEC platform 220-1:
Mp1: The Mp1 reference point between the MEC platform 220-1 and the MEC applications 212 provides service registration, service discovery, and communication support for services. It also provides other functionality such as application availability, session state relocation support procedures, traffic rules and DNS rules activation, access to persistent storage and time of day information, etc. This reference point can be used for consuming and providing service specific functionality.
Mp2: The Mp2 reference point between the MEC platform 220-1 and the data plane 235 of the virtualization infrastructure 230 may be used to instruct the data plane 235 on how to route traffic among applications 212, networks, services 227, etc.
Mp3: The Mp3 reference point between MEC platforms (e.g. the MEC platforms 220-1 and 220-2) may be used for control communication between the MEC platforms 220.

NOTE: Optionally control signaling can be exchanged between two MEC platforms in different MEC systems in order to facilitate feature specific inter-MEC system coordination. Such features include application mobility support and Vehicle-to-Everything (V2X) support.

Below please find some reference points related to the MEC management:
Mm1: The Mm1 reference point between the MEO 260 and the OSS 270 may be used for triggering the instantiation and the termination of the MEC applications 212 in the MEC system.
Mm2: The Mm2 reference point between the OSS 270 and the MEC platform manager 250 may be used for the MEC platform configuration, fault, and performance management.
Mm3: The Mm3 reference point between the MEO 260 and the MEC platform manager 250 may be used for the management of the application lifecycle, application rules and requirements and keeping track of available MEC services.
Mm4: The Mm4 reference point between the MEO 260 and the virtualization infrastructure manager 240 may be used to manage virtualized resources of the MEC host 210, including keeping track of available resource capacity, and to manage application images.
Mm5: The Mm5 reference point between the MEC platform manager 250 and the MEC platform 220 may be used to perform platform configuration, configuration of the application rules and requirements, application lifecycle support procedures, management of application relocation, etc.
Mm6: The Mm6 reference point between the MEC platform manager 250 and the virtualization infrastructure manager 240 may be used to manage virtualized resources e.g. to realize the MEC application lifecycle management 255.
Mm7: The Mm7 reference point between the virtualization infrastructure manager 240 and the virtualization infrastructure 230 may be used to manage the virtualization infrastructure 230.
Mm8: The Mm8 reference point between the user application lifecycle management proxy 280 and the OSS 270 may be used to handle device application requests for running applications 212 in the MEC system.
Mm9: The Mm9 reference point between the user application lifecycle management proxy 280 and the MEO 260 of the MEC system may be used to manage MEC applications 212 requested by the device application 285.

Below please find some reference points related to external entities:
Mx1: The Mx1 reference point between the OSS 270 and the CFS portal 275 may be used by the third-parties to request the MEC system to run applications 212 in the MEC system.
Mx2: The Mx2 reference point between the user application lifecycle management proxy 280 and the device application 285 may be used by the device application 285 to request the MEC system to run an application in the MEC system, or to move an application in or out of the MEC system. It is only available when supported by the MEC system.

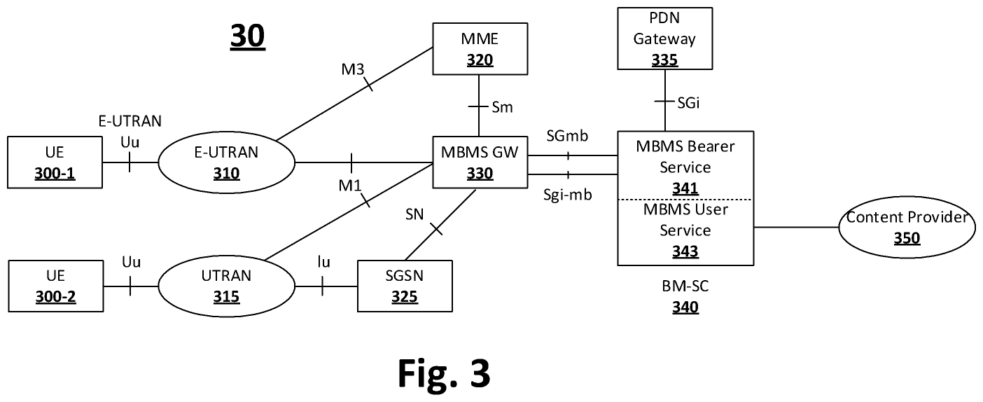

FIG. 3 is a diagram illustrating an exemplary reference architecture 30 in which MBMS is applicable according to an embodiment of the present disclosure. MBMS is a point-to-multipoint service in which data may be transmitted from a single source entity to multiple recipients. Transmitting the same data to multiple recipients allows network resources to be shared.

An MBMS bearer service may offer two modes:
Broadcast Mode; and
Multicast Mode.

Broadcast Mode is supported for EPS and GPRS, and Multicast Mode is supported for GPRS. MBMS for EPS may support E-UTRAN and UTRAN. MBMS for GPRS may support UTRAN and GERAN. The MBMS architecture enables the efficient usage of radio-network and core-network resources, with an emphasis on radio interface efficiency. MBMS is realised by the addition of a number of new capabilities to existing functional entities of the 3GPP architecture and by addition of a number of new functional entities.

As shown in FIG. 3, a functional entity MBMS GW 330 exists at the edge between the core network (CN) and the BM-SC 340. In the bearer plane, the MBMS Bearer Service 341 may provide delivery of IP Multicast datagrams from the SGi-mb reference point to UEs 300-1 and/or 300-2 with a specified Quality of Service. In the control plane, this service may provide mechanisms for:
managing the MBMS bearer service activation status of UEs (in the case of multicast mode);
outsourcing authorization decisions to the MBMS User Service 343 (i.e. to the BM-SC 340) (in the case of multicast mode);
providing control of session initiation/modification/termination by the MBMS User Service 343 and managing bearer resources for the distribution of MBMS data (in the case or multicast and broadcast modes).

A particular instance of the MBMS Bearer Service may be identified by an IP Multicast Address and an APN Network Identifier. A TMGI also can be used to identify one MBMS Bearer Service inside one PLMN.

For EPS the boundary of the MBMS Bearer Service 341 is the SGmb and the SGi-mb as shown in FIG. 3. The former provides access to the control plane functions and the latter the bearer plane.

The BM-SC 340 may provide a set of functions for MBMS User Services 343. BM-SC functions for different MBMS User Services 343 may be supported from the same or different physical network elements.

A V2X application server or a content provider 350 may apply either the MB2 or xMB reference points when managing MBMS service related information via the BM-SC 340. The MB2 reference point defined in 3GPP TS 23.468 provides functionality related to group communication and the xMB reference point defined in 3GPP TS 26.348 provides functionality overall for any content and also supports security framework between the content provider 350 and the BM-SC 340.

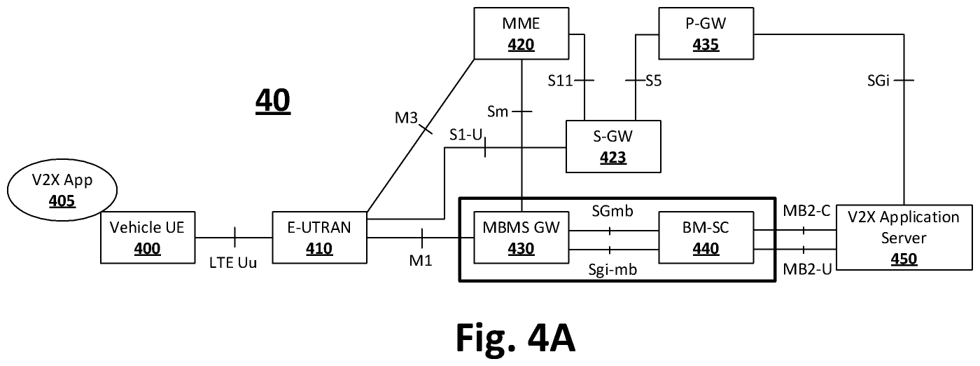

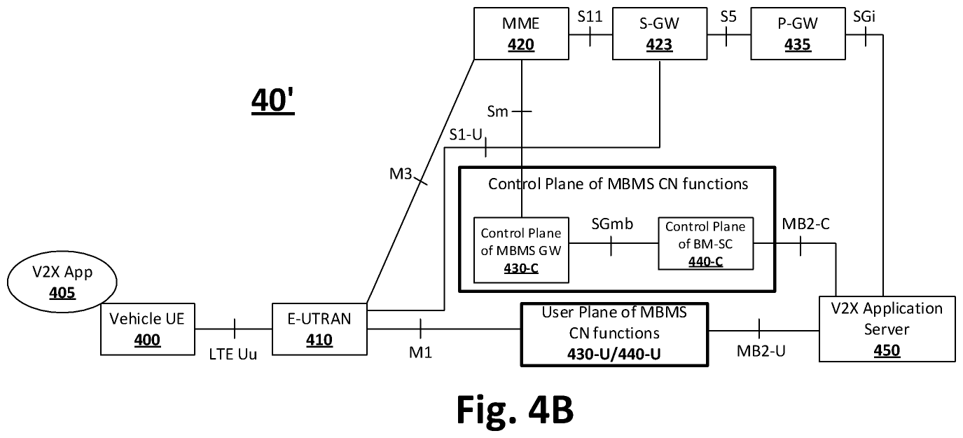

FIG. 4A and FIG. 4B are diagrams illustrating exemplary localized MBMS architectures 40 and 40′ which are applicable in an edge computing system according to an embodiment of the present disclosure.

In a current MBMS system (e.g., the MBMS system 30 shown in FIG. 3), the BM-SC 340, MBMS-GW 330, and MME 320 may be located in the CN. The backhaul delay between the BM-SC 340 and the (e)NBs 310/315 is non-negligible when calculating the end-to-end delay, especially when MBMS is used to delivery downlink V2X messages in a V2X system. To minimize the latency, possible deployment may consider the following options:
To move the MBMS CN functions (e.g., BM-SC 340, MBMS-GW 330) closer to the (e)NBs 310/315.
To move the user plane of MBMS CN functions (e.g., BM-SC 340, MBMS-GW 330) closer to the (e)NBs 310/315.

These options are illustrated in FIG. 4A and FIG. 4B, respectively. The list of deployment options is not exhaustive and that they are shown for illustration purposes only.

If the V2X Application Server 450 utilizes the xMB interface, FIG. 4A and FIG. 4B may replace MB2-C and MB2-U with xMB-C and xMB-U, respectively.

In the embodiment shown in FIG. 4A, the BM-SC 440 and the MBMS-GW 430 may be located close to the eNB 410. In the embodiment shown in FIG. 4B, the user plane of the MBMS CN functions (BM-SC 440-U and/or MBMS-GW 430-U) may be located close to the eNB 410.

The user plane of the MBMS CN functions may implement the following user plane functionalities:
Receive user data from V2X Application Server 450 over MB2-U/xMB-U.
IP multicast distribution of MBMS user plane data to E-UTRAN (M1 reference point).
Data synchronization (as for the BM-SC 340 in legacy MBMS mechanisms).
If used, apply favorable error resilient schemes, e.g. specialized MBMS codecs or Forward Error Correction schemes.
If used, MBMS data encryption.

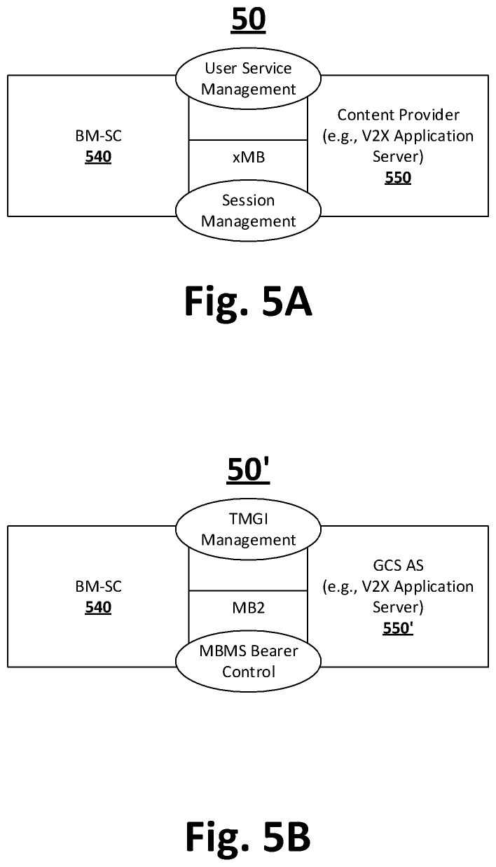

FIG. 5A and FIG. 5B are diagrams illustrating exemplary reference points between a BM-SC 540 (e.g., the BM-SC 340 shown in FIG. 3 or 440/440-C/440-U shown in FIG. 4A and FIG. 4B) and an application server 550/550′ (e.g., the content provider 350 shown in FIG. 3 or the V2X application server 450 shown in FIG. 4A and FIG. 4B) that may be applicable in an edge computing system according to an embodiment of the present disclosure. As mentioned above, MBMS may provide two types of reference points for using MBMS services:
the MB2 reference point: provided by the BM-SC 540 to the group communication system (GCS AS) 550′ for using MBMS service defined in 3GPP TS 29.468; and
the xMB reference point: the northbound interface between the BM-SC 540 and the content provider 550 for using MBMS service defined in 3GPP TS 26.348.

Both external (3rd party) content providers and 3GPP defined API invokers e.g. GCS AS 550 may use the xMB reference point to access delivery services provided by the BM-SC 540.

As shown in FIG. 5A, the content provider 550 may use xMB for MBMS user service and session management. An MBMS user service may be provided to the end user, and it can be seen by the end user through service announcement. An MBMS session may be linked to an MBMS user service and may be time bound and associated with a target broadcast/multicast area. The MBMS bearer is active between the start and stop times of the session. Further, an MBMS user service needs to be created in advance by the content provider 550, while an MBMS session may be typically created on-demand.

As shown in FIG. 5B, the GSC AS 550′ may use the MB2 reference point for MBMS TMGI management and MBMS bearer control. The BM-SC 540 may offer TMGI management functions to the GCS AS 550′ which may comprise allocating and de-allocating TMGI(s). A TMGI may be used to identify one MBMS bearer service inside one PLMN. TMGI may be allocated by the BM-SC 540 with an expiration time. The BM-SC 540 may also offer MBMS bearer control functions to the GCS AS 550′ for activating, deactivating, modifying an MBMS bearer. An MBMS bearer may be linked to a TMGI.

When MBMS is localized, there are a lot of challenges for application servers, which usually consist of central application and edge applications, to use MBMS:
Localized MBMS information provisioning: The information of localized MBMS needs to be synchronized across central application and edge applications;
MBMS user service/session lifecycle management: When an MBMS user service or session is created, updated, or deleted, the information shall be synchronized across central application and edge applications;
Localized MBMS determination: When application servers (especially edge application) wants to multicast/broadcast some content, they need to decide which one or more localized MBMSes will be communicated by comparing the MBMS service areas and target location area; and
Multiple localized MBMSes communication: Once the localized MBMSes have been determined, application servers need to communicate with them one by one and deliver the content.

In other words, there is currently no support in an edge computing system (e.g. the EC system 10 shown in FIG. 1 or the MEC system 20 shown in FIG. 2) to facilitate the usage of localized MBMS. Without the support, an application server has to implement a proprietary mechanism to coordinate central application and edge applications to tackle the challenges mentioned above.

In general, some embodiments of the present disclosure present a system level mechanism to facilitate central application and edge applications to use localized MBMS:
Edge computing system may expose an API for central application to create MBMS user services;
Edge computing system may introduce an MBMS support service in edge node for edge application to create MBMS sessions and send content; and
A mechanism to synchronize MBMS related information among edge orchestrator and edge nodes.

This mechanism may facilitate central application and edge applications in using MBMS, and reduce the complexity of central application and edge applications.

In an edge computing architecture, central application and edge applications may be responsible for the lifecycle management of different MBMS entities. For example:
Central application may be responsible for managing MBMS user service;
Edge application may be responsible for the managing MBMS session.

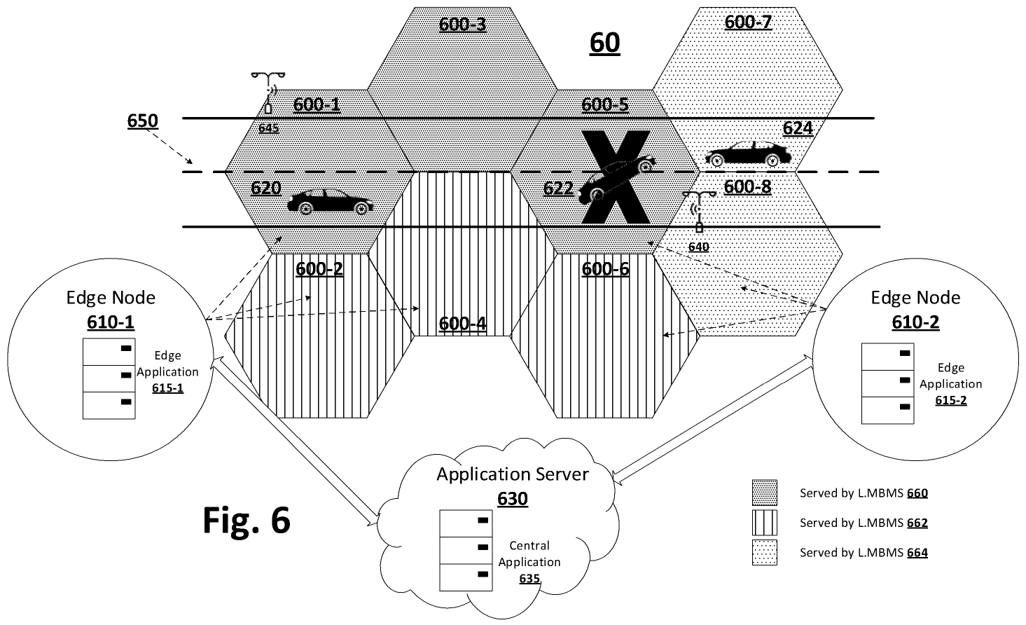

FIG. 6 is a diagram illustrating an exemplary edge computing system 60 in which localized MBMS is supported according to an embodiment of the present disclosure. As shown in FIG. 6, the edge computing system 60 may comprise one or more edge nodes 610-1 and 610-2. Each of the edge nodes 610-1 and 610-2 may be serving one or more cells. For example, the edge node 610-1 may be serving UEs (e.g., a vehicle UE 620) located in cells 600-1, 600-2, and 600-4, and the edge node 610-2 may be serving UEs (e.g., a vehicle UE 622) located in cells 600-5, 600-6, and 600-8. Further, although not shown, UEs (e.g., a vehicle UE 624) located in cells 600-3 and 600-7 may be served by one or more other edge nodes that are not shown in FIG. 6.

To be more specific, the UEs may be served by edge applications 615-1, 615-2 running at the edge nodes 610-1, 610-2. In this case, any UE may be served by an edge application running at an edge node that is close thereto and be provided with a better network performance.

As shown in FIG. 6, the vehicle UEs 620, 622, and 624 are driving on a road 650 that are covered by the cells 600-1 to the cells 600-8. Therefore when a vehicle UE (e.g., the vehicle UE 620) is moving along the road 650, its serving edge node may be changed, for example, from the edge node 610-1 to the edge node 610-2. Similarly, when the vehicle UE 624 is moving along the road 650, its serving edge node may be changed, for example, from an edge node not shown, to the edge node 610-2, another edge node not shown, and the edge node 610-1. In such cases, the information of the vehicle UEs may be communicated between the edge applications running at the edge nodes.

Further, as also shown in FIG. 6, there is an application server 630 at which a central application 635 corresponding to the edge applications 615-1/615-2 is hosted. The central application 635 may communicate with the edge applications 615-1/615-2, for example, to collect status information of the vehicle UEs and/or to provide third party services, such as, weather/traffic forecasting, navigation, etc. Further, as will be described in detail later, a “Slow Vehicle Warning Service” may be provided to the vehicle UEs by the central application 635 and the edge applications 615-1/615-2 as well as localized MBMS.

Further, as also shown in FIG. 6, one or more road side units (RSUs) 640 and 645 may be provided for V2X communication for the vehicle UEs. In some embodiments, the vehicle UEs 620, 622, and/or 624 may communicate with their serving edge nodes via the RSU 640 and/or 645 instead of, or in addition to, via their serving base stations.

Referring to FIG. 6, a localized MBMS system comprising one or more localized MBMS 660, 662, and 664 may also be deployed. Since the localized MBMS system is typically deployed independently from the edge computing system 60 and not collocated with an edge node, an area served by an edge node may be different from an area served by a localized MBMS. For example, the localized MBMS (or L.MBMS) 660 may serve the UEs located in the cells 600-1, 600-3, and 600-5 as indicted by the densely dotted area, the L.MBMS 662 may serve the UEs located in the cells 600-2, 600-4, and 600-6 as indicated by the vertically shaded area, and the L.MBMS 664 may serve the UEs located in the cells 600-7 and 600-8 as indicated by the sparsely dotted area. However, the present disclosure is not limited thereto. In some other embodiments, a different configuration of the localized MBMS system may be used.

In some embodiments, a vehicle UE (e.g., the vehicle UE 622) may transmit V2X messages via PC5 interface in V2X scenarios and may receive V2X messages via PC5 or via MBMS. A stationary infrastructure entity acting as a UE, e.g. the RSU 640 or 645, may receive V2X messages via PC5 from the vehicle UE, and may forward to a V2X edge application (e.g., the edge application 615-2) via using a PDN connection over LTE-Uu or other type of connection (for example fixed). The V2X messages processed by the V2X edge application may be distributed to other vehicle UEs (e.g., the vehicle UEs 620 and/or 624) via the MBMS system as required. Therefore, in case of any road event happens (e.g. the vehicle UE 622 is broken and/or moving slowly, which may impact the traffic), the V2X system may use the localized MBMS service to broadcast/multicast this event to other vehicle UEs in surrounding areas.

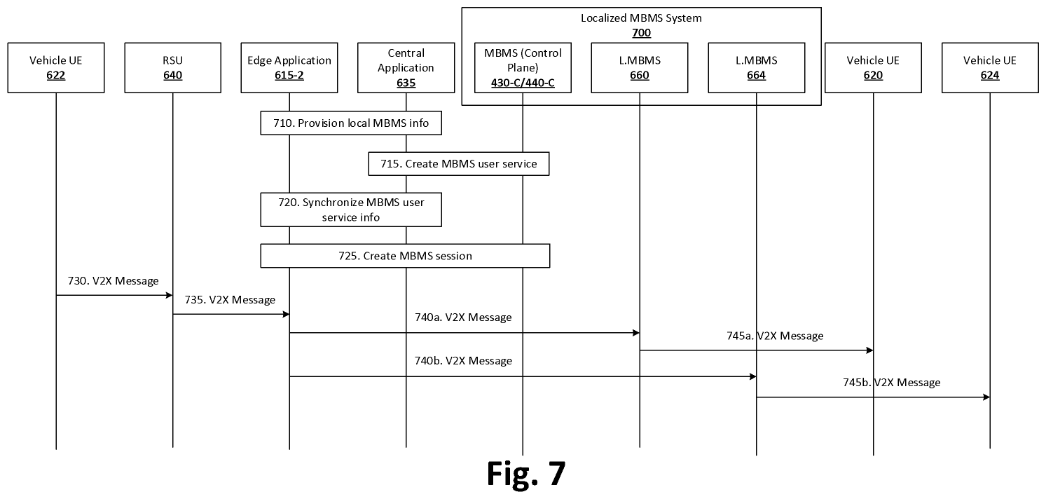

FIG. 7 is a diagram illustrating an exemplary procedure for supporting localized MBMS in the edge computing system 60 shown in FIG. 6 according to an embodiment of the present disclosure. Please note that any node shown in FIG. 7 may refer to the physical device at which the node is implemented. For example, the node “Edge Application 615-2” shown in FIG. 7 may refer to the edge node 610-2 at which the edge application 615-2 is hosted. For another example, the node “Central Application 635” shown in FIG. 7 may refer to the application server 630 at which the central application 635 is hosted. For another example, each of the L.MBMS 660 and/or L.MBMS 664 may refer to the user planes of the MBMS 430-U and/or 440-U, which is serving UEs located in its corresponding serving area.

Before the actual transmission of the V2X messages, some provisioning and/or initialization procedures may be needed.

At step 710, to use MBMS, local MBMS information may be provisioned from the V2X Central Application 635 to multiple V2X Edge Applications 615-1/615-2 hosted in different Edge Nodes. Only one edge application 615-2 is shown in FIG. 7. However, the present disclosure is not limited thereto.

At step 715, the V2X Central Application 635 may manage all V2X services and be responsible for creating MBMS User Services for V2X services in advance. For example, the V2X Central Application 635 may create an MBMS User Service called “Slow Vehicle Warning Service” that will be used for broadcasting/multicasting collision/congestion warning in an area once there is vehicle UE running slowly with emergency. This MBMS User Service may be announced to a group of eligible vehicle UEs for joining.

At step 720, the V2X Central Application 635 may synchronize the MBMS User Service—“Slow Vehicle Warning Service” information to all the V2X Edge Applications comprising the edge application 615-2.

At step 725, the V2X Edge Application 615-2 may create an MBMS session for multicasting/broadcasting real-time messages of Slow Vehicle Warning Service.

With these provisioning and/or initialization procedures, the localized MBMS and edge computing system 60 may be ready for multicasting or broadcasting V2X messages for the vehicle UEs.

As shown by FIG. 6, when the vehicle UE 622 meets an emergent situation and generates a Slow Vehicle Warning V2X message, the following steps may be performed.

At step 730, the vehicle UE 622 may transmit this V2X message to the closest RSU 640 via PC5 interface.

At step 735, the RSU 640 may forward this message to its V2X Edge Application 615-2 that is running at the edge node 610-2.

At steps 740a and 740b, the V2X Edge Application 615-2 may transmit this V2X message further to the user planes of the L.MBMS 660 and 664 that are assigned for the “Slow Vehicle Warning Service” for low latency multicasting, respectively.

At steps 745a and 745b, the L.MBMS 660 and 664 may multicast/broadcast the V2X messages to the vehicle UEs located in their serving areas, e.g., the vehicle UE 620 and the vehicle UE 640, respectively.

In this way, the localized MBMS system may be supported in the edge computing system 60, and a better network performance may be achieved by sharing the CN and RAN resources among the vehicle UEs.

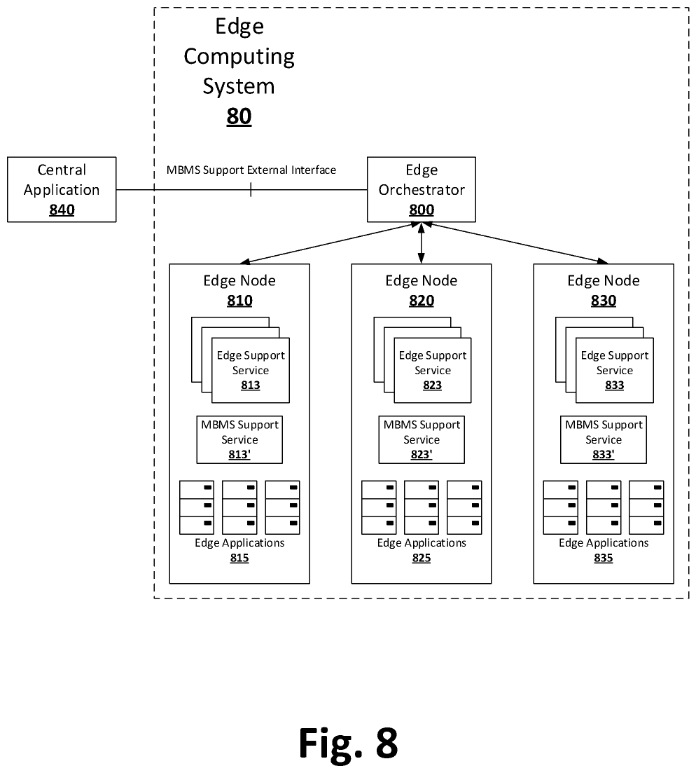

However, as also mentioned above, the central and edge applications used in the embodiment shown in FIG. 6 and FIG. 7 have to implement proprietary mechanisms for supporting localized MBMS in the edge computing system 60, resulting a lower development efficiency and a complex and cumbersome message delivery mechanism. Next, a system level support for localized MBMS in an edge computing system will be described in detail with reference to FIG. 8 to FIG. 18.

FIG. 8 is a diagram illustrating an exemplary improved edge computing system 80 in which localized MBMS may be applicable according to another embodiment of the present disclosure. The edge computing system 80 is an edge computing system improved based on the edge computing system 10 shown in FIG. 1. Therefore, similar elements are indicated by similar reference numerals, and detailed description thereof may be omitted for simplicity.

The EC system 80 extends the architecture of the EC System 10 with two entities and one interface:
a central application 840: an application that runs in an application server to serve end users or devices;
an MBMS support service 813′, 823′, 833′ hosted at edge nodes 810, 820, and 830, respectively: a service provided by an edge node to facilitate an edge application (e.g., an edge application 815, 825, or 835) to use MBMS, especially localized MBMS; and
an MBMS support external interface: an interface exposed by the edge orchestrator 800 to facilitate the central application 840 to use MBMS, especially localized MBMS.

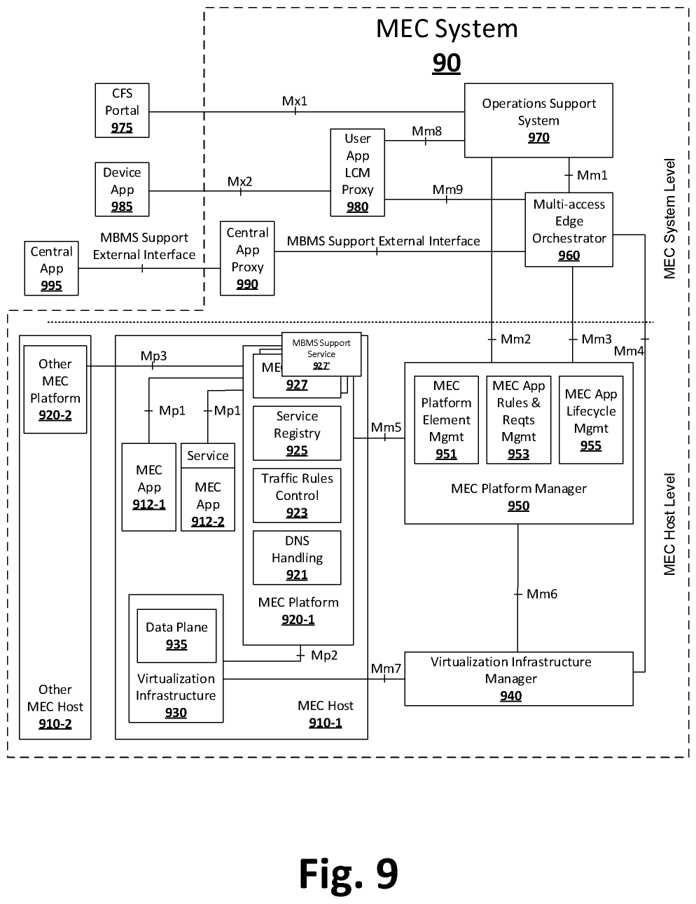

FIG. 9 is a diagram illustrating an exemplary improved implementation 90 of the edge computing system 80 shown in FIG. 8. The MEC system 90 is specific implementation of the EC system 80 shown in FIG. 8 and also a MEC system improved based on the MEC system 20 shown in FIG. 2. Therefore, similar elements are indicated by similar reference numerals, and detailed description thereof may be omitted for simplicity.

In a similar manner, the MEC system 90 extends the reference architecture of the MEC system 20 with three entities and one interface:
A central application 995: an application that runs in an application server in the central cloud to serve end users or devices;
A central application proxy 990: a proxy that authorizes requests from the central application 995 and interacts with the MEO 960 for further processing of these requests;
An MBMS support service 927′: a service provided by a mobile edge platform 920-1 to facilitate an MEC application 912-1 or 912-2 to use MBMS, especially localized MBMS; and
an MBMS support external interface: an interface exposed by the MEO 960 to facilitate the central application 995 to use MBMS, especially localized MBMS.

With the improved EC system 80 or the improved MEC system 90, a central application (e.g., the central application 840 or 995) may create MBMS user services via the MBMS support external interface exposed by the edge orchestrator 800 or the MEO 960, respectively. Further, an edge application (e.g., the edge application 815, 825, 835 or the MEC application 912-1 or 912-2) may create an MBMS session and transmit content via the MBMS support service 813′, 823′, 833′, or 927′ at the edge node 810, 820, 830, or the MEC host 910-1, respectively. Furthermore, the MBMS support service 813′, 823′, 833′, or 927′ at the edge node 810, 820, 830, or the MEC host 910-1 may coordinate the communication towards multiple L.MBMSes.

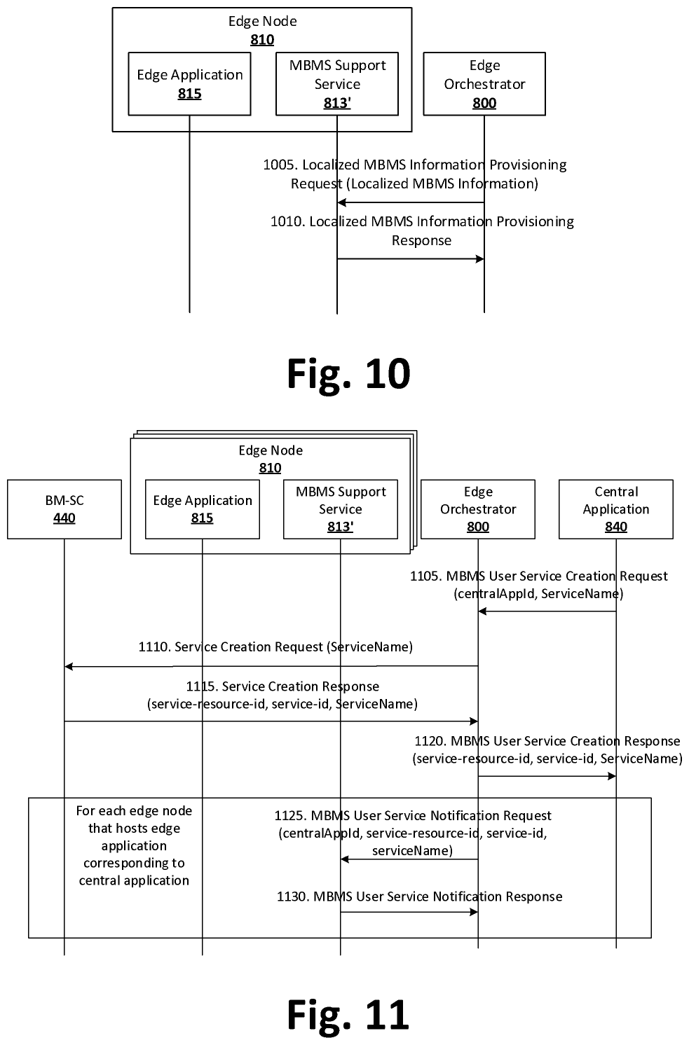

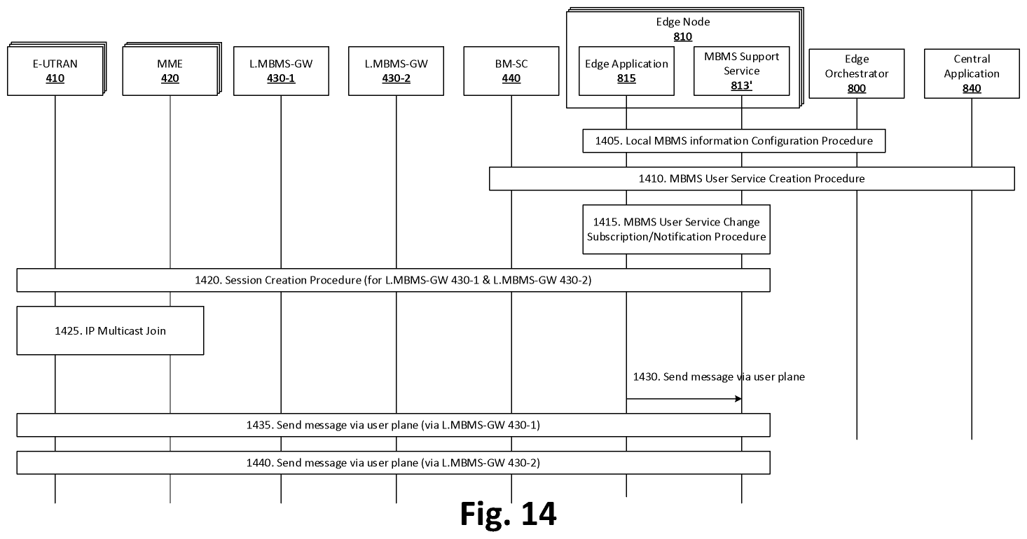

Next, a detailed description of some procedures with regard to the support of localized MBMS in an edge computing system may be given with reference to FIG. 10 to FIG. 18. Please note that any node shown in these figures may refer to the physical device at which the node is implemented. For example, the node “Edge Application 815” shown in these figures may refer to the edge node 810 at which the edge application 815 is hosted. For another example, the node “Central Application 840” shown in FIG. 14 may refer to an application server at which the central application 840 is hosted. For another example, each of the L.MBMS-GW 430-1 and/or L.MBMS-GW 430-2 may refer to the user planes of the MBMS 430-U, which is serving UEs located in its corresponding serving area. Further, although the edge application 815 and the MBMS support service 813′ are described as two separate entities in the following description, they may be actually hosted on a same edge node which may or may not be a same physical device, or on different edge nodes close to each other. Therefore, the messages communicated therebetween may be achieved by different manners, such as, network message deliver, shared memory communication, or even inter-process calls (IPCs).

FIG. 10 is a diagram illustrating an exemplary procedure for provisioning configuration for localized MBMS in an edge computing system according to an embodiment of the present disclosure.

As shown in FIG. 10, the edge orchestrator 800 may configure local MBMS information to each of the MBMS support services of the edge nodes at step 1005. Although only one edge node 810 is shown, the present disclosure is not limited thereto. In some embodiments, based on the serving area of the edge node to be provisioned, the edge orchestrator 800 may only configure relevant local MBMS information to this edge node. In other words, an edge-node-specific configuration may be provisioned by the edge orchestrator 800 to a corresponding edge node. For example, for the edge node 610-1 shown in FIG. 6 that is located in Beijing, information for the nearby localized MBMS may be provisioned, such as, those located in Beijing, Tianjin, Hebei Province, while information for localized MBMS that are located, for example, in Guangdong Province may not be provisioned to the edge node 610-1. At step 1010, the MBMS support service 813′ at the edge node 810 may transmit a response message back to the edge orchestrator 800 indicating whether the provisioning is successful or not.

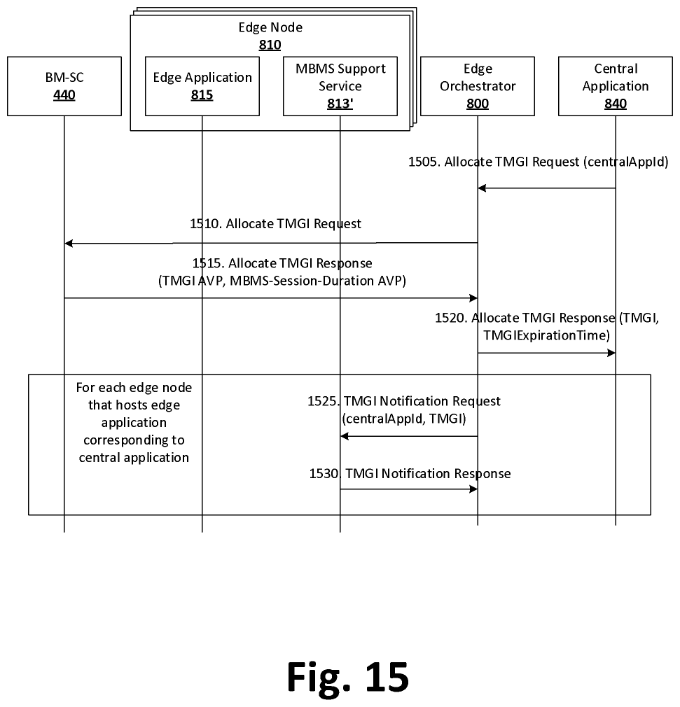

Please note that this provisioning procedure may be used with any of the xMB based procedures shown in FIG. 11 to FIG. 14 and the MB2 based procedures shown in FIG. 15 to FIG. 18, and it is independent from the specific interface used. With the localized MBMS configuration is provisioned, the edge node 810 may proceed with subsequent procedures.

Further, in some other embodiments, full information for localized MBMS may be provisioned. For example, the edge node 610-1 shown in FIG. 6 may be provisioned with the information for localized MBMS that are located in Guangdong Province, for example, to simplify the provisioning procedure.

Furthermore, this provisioning procedure is not mandatory. In some other embodiments, the information for the localized MBMS configuration may be pre-configured, for example, during the manufacture or preparation of the edge node 810.

FIG. 11 to FIG. 14 are diagrams illustrating exemplary procedures for supporting localized MBMS in an edge computing system via the xMB interface according to an embodiment of the present disclosure.

FIG. 11 is a diagram illustrating an exemplary MBMS user service creation procedure. As shown in FIG. 11, at step 1105, the central application 840 may transmit an MBMS user service creation request via the MBMS support external interface to create an MBMS user service with at least one of following parameters:
centralAppId: an ID of the central application 840; and
serviceName: a service name of the MBMS user service.

Upon reception of the request, the edge orchestrator 800 may optionally authenticate and check authorization for the received request, and may call the xMB interface provided by the BM-SC 440 to create the MBMS user service at step 1110.

Upon reception of the request, the BM-SC 440 may perform the MBMS user service creation procedure and return, via the xMB interface, a successful response with at least one of following parameters to the edge orchestrator 800 at step 1115:
resource-id: an ID of the MBMS user service resource;
service-id: a service ID set by the BM-SC 440 to identify the MBMS user service; and
serviceName: the service name of the MBMS user service.

At step 1120, the edge orchestrator 800 may return a successful response to the central application 840 with the parameters received at step 1115.

After the MBMS user service is successfully created, the edge orchestrator may notify each of the edge nodes of information of the created MBMS user service.

For each edge node (e.g., the edge node 810), the edge orchestrator 800 may notify the MBMS support service 813′ hosted at the edge node 810 of the MBMS user service information at step 1125, and the MBMS support service 813′ may return a successful response to the edge orchestrator 800 at step 1130 in response to receiving the notification request.

With the procedure shown in FIG. 11, an MBMS user service may be created for the central and edge applications for subsequent use.

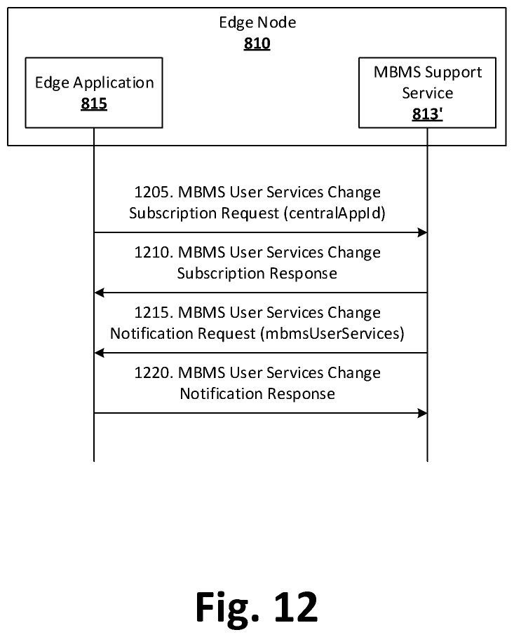

FIG. 12 is a diagram illustrating an exemplary MBMS user service change subscription/notification procedure. As shown in FIG. 12, at step 1205, the edge application 815 may transmit an MBMS user service change subscription request to the MBMS support service 813′ for the specific central app with the centralAppId (e.g., the central application 840). At step 1210, the MBMS support service 813′ may return a response to the edge application 815 to indicate that the subscription is successful. With this subscription procedure, any change of the MBMS user service may be notified to the edge application 815 in time.

After that, when any change happens in term of the MBMS user service that is relevant to the central application 840, the MBMS support service 813′ may transmit an MBMS user services change notification request with mbmsUserService to the edge application 815 at step 1215. The mbmsUserServices may comprise at least one of following parameters:
resource-id: the ID of the MBMS user service resource;
service-id: the service id set by the BM-SC 440 to identify the MBMS user service; and
serviceName: the service name of the MBMS user service.

Upon reception of the notification request, at step 1220, the edge application 815 may return a successful response to the MBMS support service 813′.

With the procedures shown in FIG. 12, the edge application 815 may be aware of any change of the created MBMS user service in time.

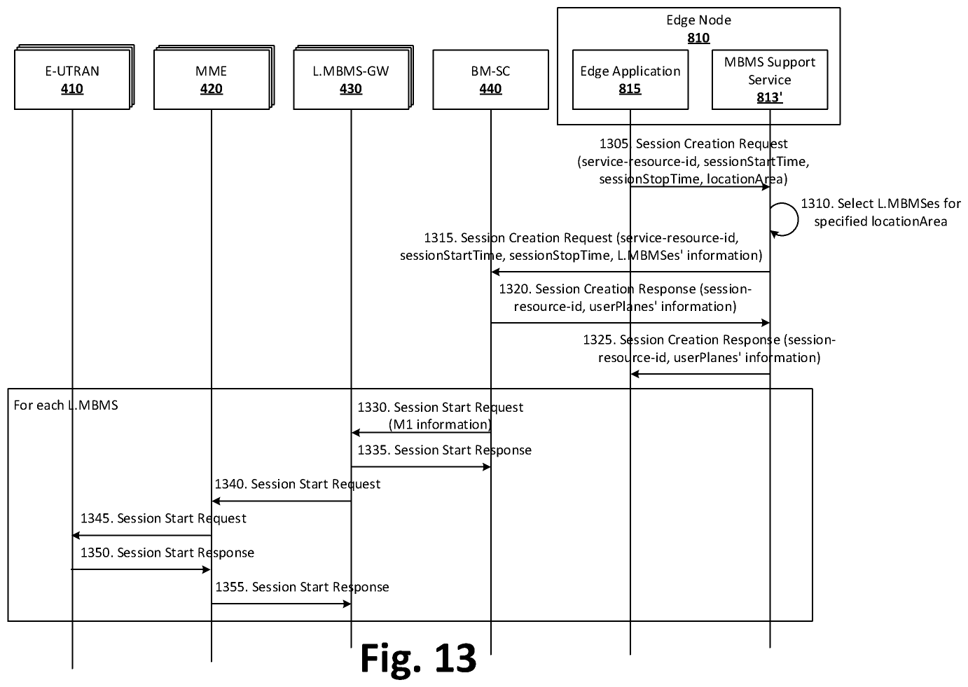

FIG. 13 is a diagram illustrating an exemplary MBMS session creation procedure. As shown in FIG. 13, at step 1305, the edge application 815 may transmit a session create request to the MBMS support service 813′ with at least one of following parameters:
resource-id: the ID of the MBMS user service resource;
sessionStartTime: the start time of the MBMS session to be created;
sessionStopTime: the stop time of the MBMS session to be created; and
locationArea: a target geographic location area of the MBMS multicast/broadcast.

At step 1310, the MBMS support service 813′ may select one or more localized MBMS GWs which are serving the specified location area, for example, based on the received “locationArea” and/or the provisioned configuration.

At step 1315, the MBMS support service 813′ may transmit, via the xMB interface, a session creation request to the BM-SC 440, which is associated with the selected MBMS GWs, with the resource-id, the sessionStartTime, the sessionStopTime, and the localized MBMS GWs information.

At step 1320, the BM-SC 440 may return, via the xMB interface, a session creation response to the MBMS support service 813′ with the session-id and userPlanes' information that contains the addresses of user planes of the localized MBMS.

At step 1325, the MBMS support service 813′ may return a session creation response to the edge application 815 with the received parameters.

After the MBMS session is created, at step 1330, for each localized MBMS GW 430, the BM-SC 440 may transmit a session start request to the localized MBMS GW 430 with M1 information to start an MBMS session. At step 1335, the localized MBMS GW 430 may return a session start response to the BM-SC 440.

At steps 1340, 1345, 1350, and 1355, the localized MBMS GW 430 may transmit the session start request to the MME 420, and then to the E-UTRAN 410, and receive a corresponding session start response therefrom.

With the procedures shown in FIG. 13, the edge application 815 may create an MBMS session for subsequent V2X message delivery.

FIG. 14 is a diagram illustrating an exemplary end-to-end procedure for supporting localized MBMS in an edge computing system. The steps 1405, 1410, 1415, and 1420 may correspond to the procedures shown in FIG. 10, FIG. 11, FIG. 12, and FIG. 13, respectively, and therefore a detailed description thereof is omitted for simplicity.

After the steps 1405 to 1420, the edge application 815 and the localized MBMS GWs 430-1 and 430-2 are ready for message delivery.

At step 1425, UEs (e.g., the vehicle UEs 620 and 624) may join a multicast group for the MBMS user service that is created by the central application 840.

At step 1430, when the edge application 815 has a message to transmit (e.g., when the edge application 815 receives a V2X message from a UE, similar to the message transmitted from the vehicle UE 622 to the edge application 615-2 shown in FIG. 6), the edge application 815 may transmit the message to the MBMS support service 813′.

Upon reception of the message, the MBMS support service 813′ may forward the message to the user planes of one or more localized MBMS GWs 430-1 and 430-2 at steps 1435 and 1430, respectively, such that any UE that joined the multicast group and served by the localized MBMS GWs 430-1 and 430-2 may receive the message.

With the mechanism shown in FIG. 10 to FIG. 14, the central application and its corresponding edge applications may use localized MBMS in a much easier manner than that shown in FIG. 6 and FIG. 7. For example, the central application and its corresponding edge applications may not care about the details of how to create/maintain/delete an MBMS user service or an MBMS session, and may need to communicate with the MBMS support service and the MBMS orchestrator only. In this way, a friendly application development may be achieved.

FIG. 15 to FIG. 18 are diagrams illustrating alternative exemplary procedures for supporting localized MBMS in an edge computing system via the MB2 interface according to an embodiment of the present disclosure.

FIG. 15 is a diagram illustrating an alternative exemplary MBMS user service creation procedure. As shown in FIG. 15, at step 1505, the central application 840 may transmit a TMGI allocation request via the MBMS support external interface to allocate a TMGI for the central application 840 with a following parameter:
centralAppId: an ID of the central application 840.

Upon reception of the request, the edge orchestrator 800 may optionally authenticate and check authorization for the received request, and may call the MB2 interface provided by the BM-SC 440 to allocate the TMGI at step 1510.

Upon reception of the request, the BM-SC 440 may perform the TMGI allocation procedure and return, via the MB2 interface, a successful response with at least one of following parameters to the edge orchestrator 800 at step 1515:
TMGI AVP: an attribute-value pair for TMGI; and
MBMS-Session-Duration AVP: an AVP for indicating the duration of the MBMS session.

At step 1520, the edge orchestrator 800 may return a successful response to the central application 840 with the parameters received at step 1515. In some embodiments, the MBMS-Session-Duration AVP may be converted into “TMGIExpirationTime” for indicating the expiration time of the TMGI.

After the TMGI is successfully allocated for the central application 840 and its corresponding edge applications 815, the edge orchestrator 800 may notify each of the edge nodes of information of the allocated TMGI.

For each edge node (e.g., the edge node 810), the edge orchestrator 800 may notify the MBMS support service 813′ hosted at the edge node 810 of the allocated TMGI and corresponding centralAppId at step 1525, and the MBMS support service 813′ may return a successful response to the edge orchestrator 800 at step 1530 in response to receiving the notification request.

With the procedure shown in FIG. 15, a TMGI may be allocated for the central and edge applications for subsequent use.

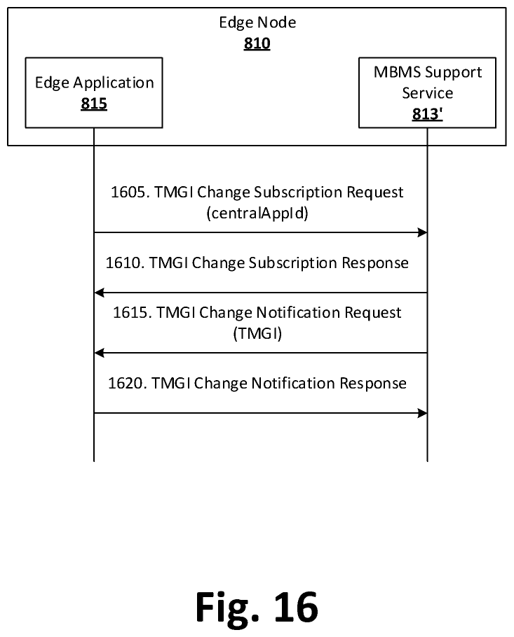

FIG. 16 is a diagram illustrating an exemplary TMGI change subscription/notification procedure. As shown in FIG. 16, at step 1605, the edge application 815 may transmit a TMGI change subscription request to the MBMS support service 813′ for the specific central app with the centralAppId (e.g., the central application 840). At step 1610, the MBMS support service 813′ may return a response to the edge application 815 to indicate that the subscription is successful. With this subscription procedure, any change of the TMGI may be notified to the edge application 815 in time.

After that, when any change happens in term of the TMGI that is relevant to the central application 840, the MBMS support service 813′ may transmit a TMGI change notification request with the latest TMGI to the edge application 815 at step 1615.

Upon reception of the notification request, at step 1620, the edge application 815 may return a successful response to the MBMS support service 813′.

With the procedures shown in FIG. 16, the edge application 815 may be aware of any change of the TMGI in time.

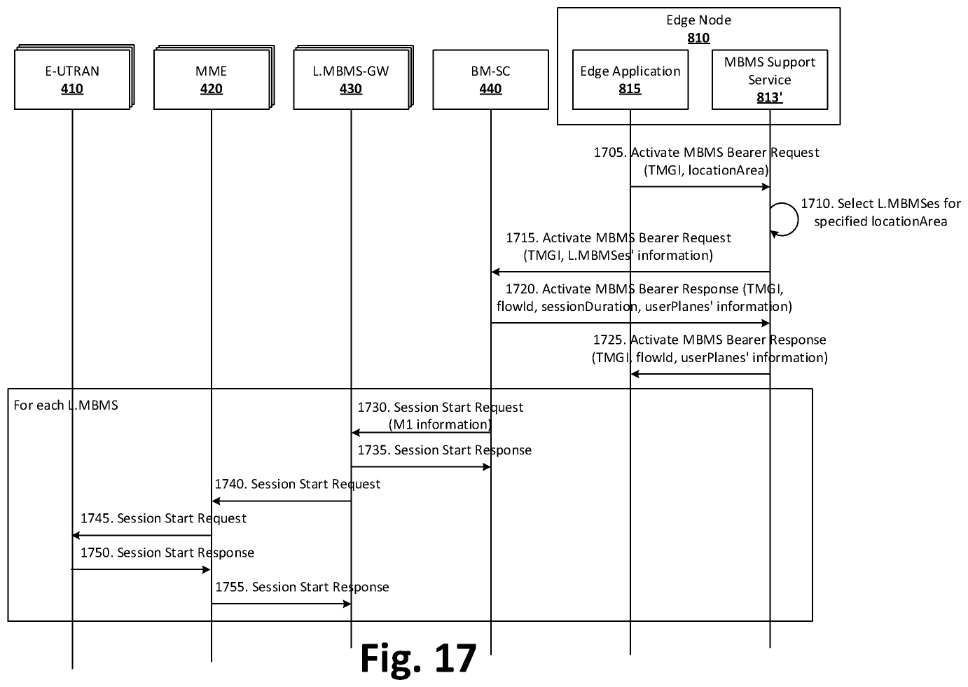

FIG. 17 is a diagram illustrating an exemplary MBMS bearer activation procedure.

As shown in FIG. 17, at step 1705, the edge application 815 may transmit an MBMS bearer activation request to the MBMS support service 813′ with at least one of following parameters:
TMGI; and
locationArea: a target geographic location area of the MBMS multicast/broadcast.

At step 1710, the MBMS support service 813′ may select one or more localized MBMS GWs which are serving the specified location area, for example, based on the received “locationArea” and/or the provisioned configuration.

At step 1715, the MBMS support service 813′ may transmit, via the MB2 interface, an MBMS bearer activation request to the BM-SC 440, which is associated with the selected MBMS GWs, with the TMGI and the localized MBMS GWs information.

At step 1720, the BM-SC 440 may return, via the MB2 interface, an MBMS bearer activation response to the MBMS support service 813′ with the TMGI, flow-Id, sessionDuration, and userPlanes' information that contains the addresses of user planes of the localized MBMS.

At step 1725, the MBMS support service 813′ may return an MBMS bearer activation response to the edge application 815 with the received parameters.

After the MBMS bearer is activated, at step 1730, for each localized MBMS GW 430, the BM-SC 440 may transmit a session start request to the localized MBMS GW 430 with M1 information to start an MBMS session. At step 1735, the localized MBMS GW 430 may return a session start response to the BM-SC 440.

At steps 1740, 1745, 1750, and 1755, the localized MBMS GW 430 may transmit the session start request to the MME 420, and then to the E-UTRAN 410, and receive a corresponding session start response therefrom.

With the procedures shown in FIG. 17, the edge application 815 may activate an MBMS bearer for subsequent V2X message delivery.

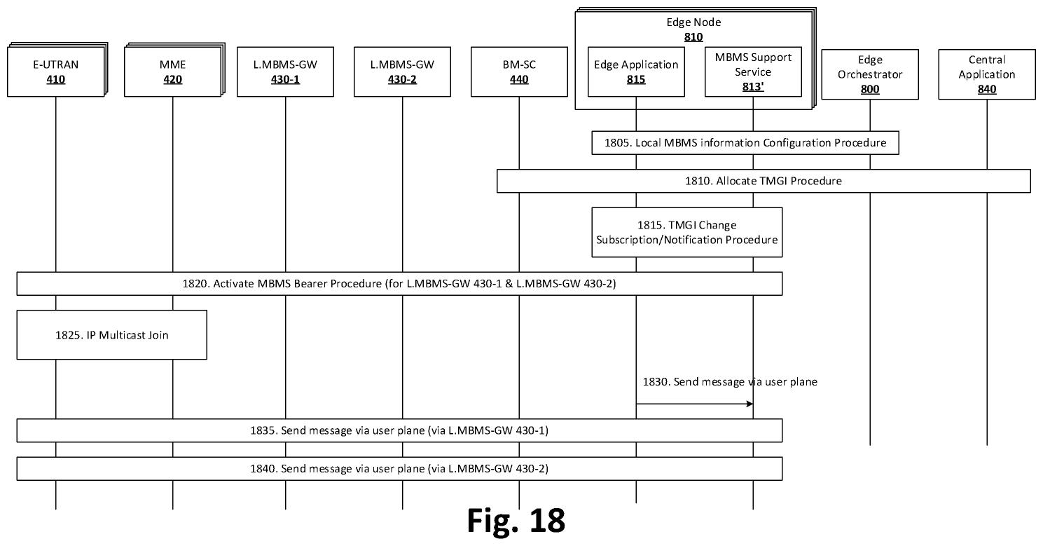

FIG. 18 is a diagram illustrating an exemplary end-to-end procedure for supporting localized MBMS in an edge computing system. The steps 1805, 1810, 1815, and 1820 may correspond to the procedures shown in FIG. 10, FIG. 15, FIG. 16, and FIG. 17, respectively, and therefore a detailed description thereof is omitted for simplicity.

After the steps 1805 to 1820, the edge application 815 and the localized MBMS GWs 430-1 and 430-2 are ready for message delivery.

At step 1825, UEs (e.g., the vehicle UEs 620 and 624) may join a multicast group for the MBMS user service that is created by the central application 840.

At step 1830, when the edge application 815 has a message to transmit (e.g., when the edge application 815 receives a V2X message from a UE, similar to the message transmitted from the vehicle UE 622 to the edge application 615-2 shown in FIG. 6), the edge application 815 may transmit the message to the MBMS support service 813′.

Upon reception of the message, the MBMS support service 813′ may forward the message to the user planes of one or more localized MBMS GWs 430-1 and 430-2 at steps 1835 and 1830, respectively, such that any UE that joined the multicast group and served by the localized MBMS GWs 430-1 and 430-2 may receive the message.

With the mechanism shown in FIG. 10 and FIG. 15 to FIG. 18, the central application and its corresponding edge applications may use localized MBMS in a much easier manner than that shown in FIG. 6 and FIG. 7. For example, the central application and its corresponding edge applications may not care about the details of how to create/maintain/delete an MBMS user service or an MBMS session, and may need to communicate with the MBMS support service and the MBMS orchestrator only. In this way, a friendly application development may be achieved.

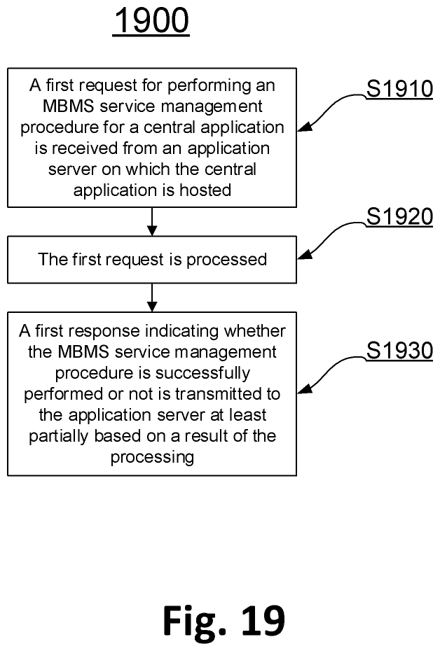

FIG. 19 is a flow chart of an exemplary method 1900 at an edge orchestrator in an edge computing system for supporting MBMS according to an embodiment of the present disclosure. The method 1900 may be performed at an edge orchestrator (e.g., the edge orchestrator 800 shown in FIG. 14 or FIG. 18). The method 1900 may comprise step S1910, S1920, and Step S1930. However, the present disclosure is not limited thereto. In some other embodiments, the method 1900 may comprise more steps, less steps, different steps, or any combination thereof. Further the steps of the method 1900 may be performed in a different order than that described herein. Further, in some embodiments, a step in the method 1900 may be split into multiple sub-steps and performed by different entities, and/or multiple steps in the method 1900 may be combined into a single step.

The method 1900 may begin at step S1910 where a first request for performing an MBMS service management procedure for the central application may be received from an application server on which a central application is hosted.

At step S1920, the first request may be processed.

At step S1930, a first response indicating whether the MBMS service management procedure is successfully performed or not may be transmitted to the application server at least partially based on a result of the processing.

In some embodiments, before the step S1910, the method 1900 may further comprise: transmitting, to each of one or more edge nodes on which an MBMS support service is hosted, a second request for provisioning a configuration at the corresponding edge node for localized MBMS; and receiving, from each of the one or more edge nodes, a second response indicating whether the configuration is successfully provisioned at the corresponding edge node or not. In some embodiments, each of the configurations may be an edge-node-specific configuration. In some embodiments, each of the configurations may be a configuration for MBMS that is local to a serving area of the corresponding edge node. In some embodiments, the MBMS service management procedure may be an MBMS user service creation procedure when the xMB interface is used, and the MBMS service management procedure may be a temporary mobile group identity (TMGI) allocation procedure when the MB2 interface is used.

In some embodiments, when the xMB interface is used, the first request may be a request for creating an MBMS user service and may comprise at least one of an identifier of the central application and a service name of the MBMS user service, and the first response may comprise at least one of an identifier of resource assigned to the MBMS user service, a service identifier assigned to the MBMS user service, and the service name of the MBMS user service. In some embodiments, the step S1920 may comprise: transmitting, to a Broadcast Multicast Service Center (BM-SC) via the xMB interface, a third request for creating the MBMS user service for the central application at least partially based on the first request; and receiving, from the BM-SC via the xMB interface, a third response indicating whether the MBMS user service is successfully created or not. In some embodiments, the third request may comprise the service name of the MBMS user service, and the third response may comprise at least one of an identifier of resource assigned to the MBMS user service, a service identifier assigned to the MBMS user service, and the service name of the MBMS user service.

In some embodiments, the method 1900 may further comprise: determining at least one edge node from the one or more edge nodes at least partially based on serving areas of the one or more edge nodes; transmitting, to each of the at least one edge node, a fourth request for notifying information for the MBMS user service; and receiving, from each of the at least one edge node, a fourth response acknowledging the fourth request. In some embodiments, the fourth request may comprise at least one of an identifier of the central application, the identifier of resource assigned to the MBMS user service, the service identifier assigned to the MBMS user service, and the service name of the MBMS user service.

In some embodiments, when the MB2 interface is used, the first request may be a request for allocating a TMGI from localized MBMS and comprises an identifier of the central application, and the first response may comprise at least one of the TMGI and an expiration time corresponding to the duration for the TMGI. In some embodiments, the step S1920 may comprise: transmitting, to a Broadcast Multicast Service Center (BM-SC) via the MB2 interface, a third request for allocating the TMGI at least partially based on the first request; and receiving, from the BM-SC via the MB2 interface, a third response indicating whether the TMGI is successfully allocated or not. In some embodiments, the third response may comprise at least one of an allocated TMGI and a duration for the allocated TMGI.

In some embodiments, the method may further comprise: determining at least one edge node from the one or more edge nodes at least partially based on serving areas of the one or more edge nodes; transmitting, to each of the at least one edge node, a fourth request for notifying the allocated TMGI; and receiving, from each of the at least one edge node, a fourth response acknowledging the fourth request. In some embodiments, the fourth request may comprise at least one of an identifier of the central application and the allocated TMGI.

In some embodiments, the step S1920 may further comprise authenticating the application server for the first request, wherein the step S1930 may comprise: transmitting, to the application server, a first response indicating that the MBMS service management procedure is not successfully performed in response to determining that the application server is not successfully authenticated; or transmitting, to the application server, a first response indicating that the MBMS service management procedure is successfully performed at least partially based on determining that the application server is successfully authenticated.

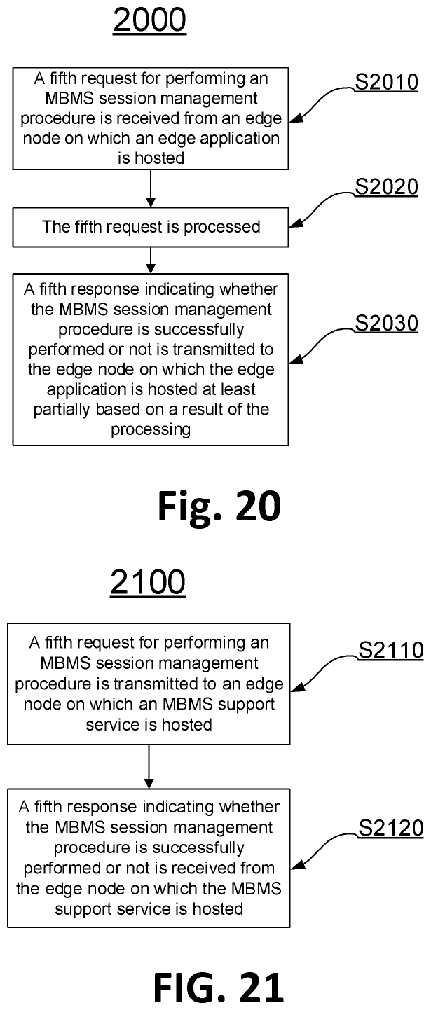

FIG. 20 is a flow chart of an exemplary method 2000 at an edge node, on which an MBMS support service is hosted, in an edge computing system for supporting localized MBMS according to an embodiment of the present disclosure. The method 2000 may be performed at an edge node (e.g., the edge node 810 shown in FIG. 14 or FIG. 18). The method 2000 may comprise step S2010, S2020, and Step S2030. However, the present disclosure is not limited thereto. In some other embodiments, the method 2000 may comprise more steps, less steps, different steps, or any combination thereof. Further the steps of the method 2000 may be performed in a different order than that described herein. Further, in some embodiments, a step in the method 2000 may be split into multiple sub-steps and performed by different entities, and/or multiple steps in the method 2000 may be combined into a single step.

The method 2000 may begin at step S2010 where a fifth request for performing an MBMS session management procedure may be received from an edge node on which an edge application is hosted.

At step S2020, the fifth request may be processed.

At step S2030, a fifth response indicating whether the MBMS session management procedure is successfully performed or not may be transmitted to the edge node on which the edge application is hosted at least partially based on a result of the processing.

In some embodiments, before the step S2010, the method 2000 may further comprise: receiving, from an edge orchestrator, a second request for provisioning a configuration for localized MBMS; provisioning the configuration; and transmitting, to the edge orchestrator, a second response indicating whether the configuration is successfully provisioned or not at least partially based on a result of the provisioning. In some embodiments, the configuration may be an edge-node-specific configuration. In some embodiments, the configuration may be a configuration for MBMS that is local to a serving area of the edge node on which the MBMS support service is hosted. In some embodiments, the MBMS session management procedure may be an MBMS session creation procedure when the xMB interface is used, and the MBMS session management procedure may be an MBMS bearer activation procedure when the MB2 interface is used.

In some embodiments, when the xMB interface is used, the fifth request may be a request for creating an MBMS session and may comprise at least one of an identifier of resource assigned to an MBMS user service, a session start time, a session stop time, and an indicator indicating a location area, and the fifth response may comprise at least one of an identifier of resource assigned to the MBMS session and information for one or more user plane entities. In some embodiments, the step S2020 may comprise: determining one or more localized MBMS gateways (GWs) for creating the MBMS session at least partially based on the configuration for localized MBMS, serving areas of the one or more localized MBMS GWs, and/or the location area; transmitting, to each of BM-SCs associated with the one or more localized MBMS GWs, a sixth request for creating the MBMS session; and receiving, from each of the BM-SCs, a sixth response indicating whether the MBMS session is successfully created or not. In some embodiments, the sixth request may comprise at least one of the identifier of resource assigned to the MBMS user service, the session start time, the session stop time, and information for the one or more localized MBMS GWs, and the sixth response may comprise at least one of the identifier of resource assigned to the MBMS session and the information for one or more user plane entities.

In some embodiments, before the step S2010, the method 2000 may further comprise: receiving, from the edge orchestrator, a fourth request for notifying information for the MBMS user service; processing the information for the MBMS user service; and transmitting, to the edge orchestrator, a fourth response acknowledging the fourth request. In some embodiments, the fourth request may comprise at least one of an identifier of a central application associated with the edge application, an identifier of resource assigned to the MBMS user service, a service identifier assigned to the MBMS user service, and a service name of the MBMS user service.

In some embodiments, after the step of transmitting the fourth response and before the step S2010, the method 2000 may further comprise: receiving, from the edge node on which the edge application is hosted, a seventh request for subscribing an MBMS user service change notification; transmitting, to the edge node on which the edge application is hosted, a seventh response indicating whether the MBMS user service change notification is successfully subscribed or not, wherein the method 2000 may further comprises in response to determining that the seventh response indicates that the MBMS user service change notification is successfully subscribed: transmitting, to the edge node on which the edge application is hosted, an eighth request for notifying a change in the MBMS user service; and receiving, from the edge node on which the edge application is hosted, an eighth response for acknowledging the eighth request. In some embodiments, the seventh request may comprise at least an identifier of the central application, and the eighth request may comprise at least one of an identifier of resource assigned to the MBMS user service, a service identifier assigned to the MBMS user service, and the service name of the MBMS user service.

In some embodiments, when the MB2 interface is used, the fifth request may be a request for activating an MBMS bearer and comprises at least one of a temporary mobile group identity (TMGI) and an indicator indicating a location area, and the fifth response may comprise at least one of the TMGI, an assigned flow identifier, and information for one or more user plane entities.

In some embodiments, the step S2020 may comprise: determining one or more localized MBMS gateways (GWs) for activating the MBMS bearer at least partially based on the configuration for localized MBMS, serving areas of the one or more localized MBMS GWs, and/or the location area; transmitting, to each of BM-SCs associated with the one or more localized MBMS GWs, a sixth request for activating the MBMS bearer; and receiving, from each of the BM-SCs, a sixth response indicating whether the MBMS bearer is successfully activated or not. In some embodiments, the sixth request may comprise at least one of the TMGI and information for the one or more localized MBMS GWs, and the sixth response may comprise at least one of the TMGI, the assigned flow identifier, a duration of the session associated with the flow, and information for one or more user plane entities.

In some embodiments, before the step S2010, the method 2000 may further comprise: receiving, from the edge orchestrator, a fourth request for notifying the TMGI and the identifier of the central application; storing the TMGI and the identifier of the central application in an associated manner; and transmitting, to the edge orchestrator, a fourth response acknowledging the fourth request. In some embodiments, after the step of transmitting the fourth response and before the step S2010, the method 2000 may further comprise: receiving, from the edge node on which the edge application is hosted, a seventh request for subscribing a TMGI change notification; and transmitting, to the edge node on which the edge application is hosted, a seventh response indicating whether the TMGI change notification is successfully subscribed or not, wherein the method 2000 may further comprise in response to determining that the seventh response indicates that the TMGI change notification is successfully subscribed: transmitting, to the edge node on which the edge application is hosted, an eighth request for notifying a change of the TMGI; and receiving, from the edge node on which the edge application is hosted, an eighth response for acknowledging the eighth request. In some embodiments, the seventh request may comprise at least an identifier of the central application, and the eighth request may comprise the latest TMGI associated with the central application.

In some embodiments, the method 2000 may further comprise: forwarding a message from a user equipment (UE) via the edge application to the BM-SC for multicasting or broadcasting.

FIG. 21 is a flow chart of an exemplary method 2100 at an edge node, on which an edge application is hosted, in an edge computing system for supporting localized MBMS according to an embodiment of the present disclosure. The method 2100 may be performed at an edge node (e.g., the edge node 810 shown in FIG. 14 or FIG. 18). The method 2100 may comprise step S2110 and Step S2120. However, the present disclosure is not limited thereto. In some other embodiments, the method 2100 may comprise more steps, less steps, different steps, or any combination thereof. Further the steps of the method 2100 may be performed in a different order than that described herein. Further, in some embodiments, a step in the method 2100 may be split into multiple sub-steps and performed by different entities, and/or multiple steps in the method 2100 may be combined into a single step.

The method 2100 may begin at step S2110 where a fifth request for performing an MBMS session management procedure may be transmitted to an edge node on which an MBMS support service is hosted.

At step S2120, a fifth response indicating whether the MBMS session management procedure is successfully performed or not may be received from the edge node on which the MBMS support service is hosted.

In some embodiments, the MBMS session management procedure may be an MBMS session creation procedure when the xMB interface is used, and the MBMS session management procedure may be an MBMS bearer activation procedure when the MB2 interface is used.

In some embodiments, when the xMB interface is used, the fifth request may be a request for creating an MBMS session and may comprise at least one of an identifier of resource assigned to an MBMS user service, a session start time, a session stop time, and an indicator indicating a location area, and the fifth response may comprise at least one of an identifier of resource assigned to the MBMS session and information for one or more user plane entities. In some embodiments, before the step S2110, the method 2100 may further comprise: transmitting, to the edge node on which the MBMS support service is hosted, a seventh request for subscribing an MBMS user service change notification; and receiving, from the edge node on which the MBMS support service is hosted, a seventh response indicating whether the MBMS user service change notification is successfully subscribed or not, wherein the method 2100 may further comprise in response to determining that the seventh response indicates that the MBMS user service change notification is successfully subscribed: receiving, from the edge node on which the MBMS support service is hosted, an eighth request for notifying a change in the MBMS user service; and transmitting, to the edge node on which the MBMS support service is hosted, an eighth response for acknowledging the eighth request. In some embodiments, the seventh request may comprise at least an identifier of the central application, and the eighth request comprises at least one of an identifier of resource assigned to the MBMS user service, a service identifier assigned to the MBMS user service, and the service name of the MBMS user service.

In some embodiments, when the MB2 interface is used, the fifth request may be a request for activating an MBMS bearer and comprises at least one of a temporary mobile group identity (TMGI) and an indicator indicating a location area, and the fifth response may comprise at least one of the TMGI, an assigned flow identifier, and information for one or more user plane entities.

In some embodiments, before the step S2110, the method 2100 may further comprise: transmitting, to the edge node on which the MBMS support service is hosted, a seventh request for subscribing a TMGI change notification; and receiving, from the edge node on which the MBMS support service is hosted, a seventh response indicating whether the TMGI change notification is successfully subscribed or not, wherein the method 2100 may further comprise in response to determining that the seventh response indicates that the TMGI change notification is successfully subscribed: receiving, from the edge node on which the MBMS support service is hosted, an eighth request for notifying a change of the TMGI; and transmitting, to the edge node on which the MBMS support service is hosted, an eighth response for acknowledging the eighth request. In some embodiments, the seventh request may comprise at least an identifier of the central application, and the eighth request may comprise the latest TMGI associated with the central application. In some embodiments, the method 2100 may further comprise: forwarding a message from a user equipment (UE) to the edge node, on which the MBMS support service is hosted, for multicasting or broadcasting.

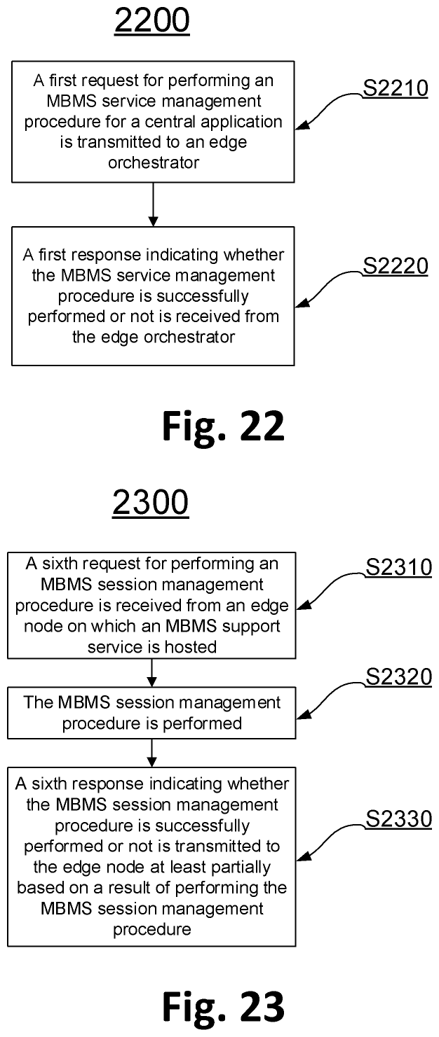

FIG. 22 is a flow chart of an exemplary method 2200 at an application server, on which a central application is hosted, in an edge computing system for supporting localized MBMS according to an embodiment of the present disclosure. The method 2200 may be performed at an edge node (e.g., the central application 840 shown in FIG. 14 or FIG. 18). The method 2200 may comprise step S2210 and Step S2220. However, the present disclosure is not limited thereto. In some other embodiments, the method 2200 may comprise more steps, less steps, different steps, or any combination thereof. Further the steps of the method 2200 may be performed in a different order than that described herein. Further, in some embodiments, a step in the method 2200 may be split into multiple sub-steps and performed by different entities, and/or multiple steps in the method 2200 may be combined into a single step.

The method 2200 may begin at step S2210 where a first request for performing an MBMS service management procedure for the central application may be transmitted to an edge orchestrator.

At step S2220, a first response indicating whether the MBMS service management procedure is successfully performed or not may be received from the edge orchestrator.

In some embodiments, the MBMS service management procedure may be an MBMS user service creation procedure when the xMB interface is used, and the MBMS service management procedure may be a temporary mobile group identity (TMGI) allocation procedure when the MB2 interface is used. In some embodiments, when the xMB interface is used, the first request may be a request for creating an MBMS user service and may comprise at least one of an identifier of the central application and a service name of the MBMS user service, and the first response may comprise at least one of an identifier of resource assigned to the MBMS user service, a service identifier assigned to the MBMS user service, and the service name of the MBMS user service. In some embodiments, when the MB2 interface is used, the first request may be a request for allocating a TMGI from localized MBMS and may comprise an identifier of the central application, and the first response may comprise at least one of the TMGI and an expiration time corresponding to the duration for the TMGI.

FIG. 23 is a flow chart of an exemplary method 2300 at a BM-SC in a localized MBMS system for supporting an edge computing system according to an embodiment of the present disclosure. The method 2300 may be performed at a BM-SC (e.g., the BM-SC 440 shown in FIG. 14 or FIG. 18). The method 2300 may comprise step S2310, S2320, and Step S2330. However, the present disclosure is not limited thereto. In some other embodiments, the method 2300 may comprise more steps, less steps, different steps, or any combination thereof. Further the steps of the method 2300 may be performed in a different order than that described herein. Further, in some embodiments, a step in the method 2300 may be split into multiple sub-steps and performed by different entities, and/or multiple steps in the method 2300 may be combined into a single step.

The method 2300 may begin at step S2310 where a sixth request for performing an MBMS session management procedure may be received from an edge node on which an MBMS support service is hosted.

At step S2320, the MBMS session management procedure may be performed.

At step S2330, a sixth response indicating whether the MBMS session management procedure is successfully performed or not may be transmitted to the edge node at least partially based on a result of performing the MBMS session management procedure.

In some embodiments, before the step S2310, the method 2300 may further comprise: receiving, from an edge orchestrator, a third request for performing an MBMS service management procedure for a central application; performing the MBMS service management procedure; and transmitting, to the edge orchestrator, a third response indicating whether the MBMS service management procedure is successfully performed or not at least partially based on a result of performing the MBMS service management procedure. In some embodiments, the MBMS session management procedure may be an MBMS session creation procedure and the MBMS service management procedure may be an MBMS user service creation procedure when the xMB interface is used, and the MBMS session management procedure may be an MBMS bearer activation procedure and the MBMS service management procedure may be a temporary mobile group identity (TMGI) allocation procedure when the MB2 interface is used.

In some embodiments, when the xMB interface is used, the third request many comprise a service name of an MBMS user service, and the third response may comprise at least one of an identifier of resource assigned to the MBMS user service, a service identifier assigned to the MBMS user service, and the service name of the MBMS user service, wherein when the xMB interface is used, the sixth request may comprise at least one of an identifier of resource assigned to the MBMS user service, a session start time, a session stop time, and information for one or more localized MBMS GWs associated with the BM-SC, and the sixth response may comprise at least one of an identifier of resource assigned to the MBMS session and information for one or more user plane entities.

In some embodiments, when the MB2 interface is used, the third response may comprise at least one of an allocated TMGI and a duration for the allocated TMGI, when the MB2 interface is used, the sixth request may comprise at least one of the TMGI and information for the one or more localized MBMS GWs, and the sixth response may comprise at least one of the TMGI, the assigned flow identifier, a duration of the session associated with the flow, and information for one or more user plane entities.

In some embodiments, the method may further comprise: transmitting, to the one or more localized MBMS GWs, one or more ninth requests for starting an MBMS session, respectively; and receiving, from the one or more localized MBMS GWs, one or more ninth responses indicating whether a MBMS session is started or not, respectively. In some embodiments, the method may further comprise: forwarding a message from the edge node, on which an MBMS support service is hosted, to at least one of the one or more localized MBMS GWs for multicasting or broadcasting.

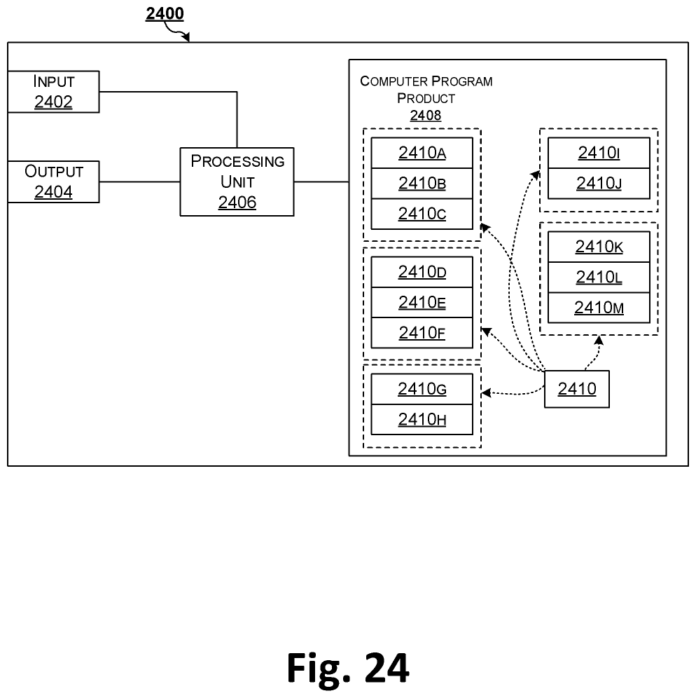

FIG. 24 schematically shows an embodiment of an arrangement which may be used in an edge orchestrator, an edge node, an application server, and/or a BM-SC according to an embodiment of the present disclosure. Comprised in the arrangement 2400 are a processing unit 2406, e.g., with a Digital Signal Processor (DSP) or a Central Processing Unit (CPU). The processing unit 2406 may be a single unit or a plurality of units to perform different actions of procedures described herein. The arrangement 2400 may also comprise an input unit 2402 for receiving signals from other entities, and an output unit 2404 for providing signal(s) to other entities. The input unit 2402 and the output unit 2404 may be arranged as an integrated entity or as separate entities.

Furthermore, the arrangement 2400 may comprise at least one computer program product 2408 in the form of a non-volatile or volatile memory, e.g., an Electrically Erasable Programmable Read-Only Memory (EEPROM), a flash memory and/or a hard drive. The computer program product 2408 comprises a computer program 2410, which comprises code/computer readable instructions, which when executed by the processing unit 2406 in the arrangement 2400 causes the arrangement 2400 and/or the first network element and/or the second network element in which it is comprised to perform the actions, e.g., of the procedure described earlier in conjunction with FIG. 7, FIG. 10 to FIG. 23 or any other variant.

The computer program 2410 may be configured as a computer program code structured in computer program modules 2410A-2410C. Hence, in an exemplifying embodiment when the arrangement 2400 is used in an edge orchestrator, the code in the computer program of the arrangement 2400 includes: a module 2410A for receiving, from an application server on which a central application is hosted, a first request for performing an MBMS service management procedure for the central application; a module 2410B for processing the first request; and a module 2410C for transmitting, to the application server, a first response indicating whether the MBMS service management procedure is successfully performed or not at least partially based on a result of the processing.

The computer program 2410 may be further configured as a computer program code structured in computer program modules 2410D-2410F. Hence, in an exemplifying embodiment when the arrangement 2400 is used in an edge node, the code in the computer program of the arrangement 2400 includes: a module 2410D for receiving, from an edge node on which an edge application is hosted, a fifth request for performing an MBMS session management procedure; a module 2410E for processing the fifth request; and a module 2410F for transmitting, to the edge node on which the edge application is hosted, a fifth response indicating whether the MBMS session management procedure is successfully performed or not at least partially based on a result of the processing.

The computer program 2410 may be further configured as a computer program code structured in computer program modules 2410G-2410H. Hence, in an exemplifying embodiment when the arrangement 2400 is used in an edge node, the code in the computer program of the arrangement 2400 includes: a module 2410G for transmitting, to an edge node on which an MBMS support service is hosted, a fifth request for performing an MBMS session management procedure; and a module 2410H for receiving, from the edge node on which the MBMS support service is hosted, a fifth response indicating whether the MBMS session management procedure is successfully performed or not.

The computer program 2410 may be further configured as a computer program code structured in computer program modules 24101-2410J. Hence, in an exemplifying embodiment when the arrangement 2400 is used in an edge node, the code in the computer program of the arrangement 2400 includes: a module 2410I for transmitting, to an edge orchestrator, a first request for performing an MBMS service management procedure for the central application; and a module 2410J for receiving, from the edge orchestrator, a first response indicating whether the MBMS service management procedure is successfully performed or not.

The computer program 2410 may be further configured as a computer program code structured in computer program modules 2410K-2410M. Hence, in an exemplifying embodiment when the arrangement 2400 is used in a BM-SC, the code in the computer program of the arrangement 2400 includes: a module 2410K for receiving, from an edge node on which an MBMS support service is hosted, a sixth request for performing an MBMS session management procedure; a module 2410L for performing the MBMS session management procedure; and a module 2410M for transmitting, to the edge node, a sixth response indicating whether the MBMS session management procedure is successfully performed or not at least partially based on a result of performing the MBMS session management procedure.

The computer program modules could essentially perform the actions of the flow illustrated in FIG. 7 and/or FIG. 10 to FIG. 23, to emulate the edge orchestrator, the edge node, the application server, and/or the BM-SC. In other words, when the different computer program modules are executed in the processing unit 2406, they may correspond to different modules in the edge orchestrator, the edge node, the application server, and/or the BM-SC.

Although the code means in the embodiments disclosed above in conjunction with FIG. 24 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

### Abbreviation Explanation

AMS Application Mobility Service
BM-SC Broadcast Multicast-Service Center
CV Connected Vehicle
GCS AS Group Communication System Application Server
MBMS Multimedia Broadcast/Multicast Service
MBMS-GW MBMS Gateway
MEC Multi-access Edge Computing
MEO Multi-access Edge Orchestrator
MEP Multi-access Edge Platform
S-MEP Source Multi-access Edge Platform
T-MEP Target Multi-access Edge Platform
TMGI Temporary Mobile Group Identity
RNIS Radio Network Information Service
RSU Road-Side Unit
V2X Vehicle-to-Everything

1.-63. (canceled)

64. A method performed by an edge orchestrator in an edge computing system, the method comprising:
receiving, from an application server that hosts a central application, a first request for performing an Multimedia Broadcast/Multicast Service (MBMS)service management procedure for the central application;
processing the first request; and
transmitting, to the application server, a first response indicating whether the MBMS service management procedure was successfully performed, wherein the first response is at least partially based on a result of the processing.

65. The method of claim 64, further comprising, before receiving the first request:
transmitting, to each of one or more edge nodes that host an MBMS support service, a second request for provisioning a configuration at the corresponding edge node for localized MBMS; and
receiving, from each of the one or more edge nodes, a second response indicating whether the configuration is successfully provisioned at the corresponding edge node.

66. The method of claim 64, wherein the MBMS service management procedure is an MBMS user service creation procedure and an xMB interface is used to process the first request.

67. The method of claim 66, wherein:
the first request is a request for creating an MBMS user service and comprises at least one of the following: an identifier of the central application, and a service name of the MBMS user service; and
the first response comprises at least one the following: an identifier of a resource assigned to the MBMS user service, a service identifier assigned to the MBMS user service, and the service name of the MBMS user service.

68. The method of claim 67, wherein processing the first request comprises:
transmitting, to a Broadcast Multicast Service Center (BM-SC) via the xMB interface, a third request for creating the MBMS user service for the central application, the third request being at least partially based on the first request; and
receiving, from the BM-SC via the xMB interface, a third response indicating whether the MBMS user service is successfully created.

69. The method of claim 68, wherein:
the third request comprises the service name of the MBMS user service; and
the third response comprises at least one of the following: the identifier of the resource assigned to the MBMS user service, the service identifier assigned to the MBMS user service, and the service name of the MBMS user service.

70. The method of claim 67, further comprising:
selecting at least one of the one or more edge nodes that host the MBMS support service, based at least partially on the respective serving areas of the one or more edge nodes;
transmitting, to each of the selected edge nodes, a fourth request for notifying information for the MBMS user service; and
receiving, from each of the selected edge nodes, a fourth response acknowledging the fourth request.

71. The method of claim 70, wherein the fourth request comprises at least one of the following: an identifier of the central application, the identifier of a resource assigned to the MBMS user service, the service identifier assigned to the MBMS user service, and the service name of the MBMS user service.

72. An edge orchestrator configured to operate in an edge computing system, the edge orchestrator comprising:
a processor;
a memory storing instructions that, when executed by the processor, cause the edge orchestrator to:
receive, from an application server that hosts a central application, a first request for performing an Multimedia Broadcast/Multicast Service (MBMS) service management procedure for the central application;
process the first request; and
transmit, to the application server, a first response indicating whether the MBMS service management procedure was successfully performed, wherein the first response is at least partially based on a result of the processing.

73. A method performed by an edge node configured to host a Multimedia Broadcast/Multicast Service (MBMS) support service in an edge computing system, the method comprising:
receiving, from an edge node that hosts an edge application, a fifth request for performing an MBMS session management procedure;
processing the fifth request; and
transmitting, to the edge node that hosts the edge application, a fifth response indicating whether the MBMS session management procedure was successfully performed, wherein the fifth response is at least partially based on a result of the processing.

74. The method of claim 73, further comprising, before receiving the fifth request:
receiving, from an edge orchestrator in the edge computing system, a second request for provisioning a configuration for localized MBMS;
provisioning the configuration in accordance with the request; and
transmitting, to the edge orchestrator, a second response indicating whether the configuration is successfully provisioned, wherein the second response is at least partially based on a result of the provisioning.

75. The method of claim 73, wherein the MBMS session management procedure is an MBMS session creation procedure and an xMB interface is used to process the fifth request

76. The method of claim 75, wherein:
the fifth request is a request for creating an MBMS session;
the fifth request comprises at least one of the following: an identifier of a resource assigned to an MBMS user service, a session start time, a session stop time, and an indication of a location area; and
the fifth response comprises at least one of the following: the identifier of a resource assigned to the MBMS session, and information about one or more user plane entities.

77. The method of claim 76, wherein processing the fifth request comprises:
selecting one or more localized MBMS gateways (GWs) for creating the MBMS session, based on one or more of the following: the configuration for localized MBMS, respective serving areas of the one or more localized MBMS GWs, and the location area indicated by the fifth request;
transmitting, to each Broadcast Multicast Service Center (BM-SC) associated with the selected localized MBMS GWs, a sixth request for creating the MBMS session; and
receiving, from each BM-SC associated with the selected localized MBMS GWs, a sixth response indicating whether the MBMS session was successfully created.

78. The method of claim 77, wherein:
the sixth request comprises at least one of the following: the identifier of a resource assigned to the MBMS user service, the session start time, the session stop time, and information about the one or more localized MBMS GWs; and
the sixth response comprises at least one of the following: the identifier of a resource assigned to the MBMS session, and the information about one or more user plane entities.

79. The method of claim 78, further comprising, before receiving the fifth request:
receiving, from the edge orchestrator, a fourth request for notifying information for the MBMS user service;
processing the information for the MBMS user service; and
transmitting, to the edge orchestrator, a fourth response that acknowledges the fourth request.

80. The method of claim 79, wherein the fourth request comprises at least one of the following: an identifier of a central application associated with the edge application, the identifier of a resource assigned to the MBMS user service, a service identifier assigned to the MBMS user service, and a service name of the MBMS user service.

81. The method of claim 80, further comprising, after transmitting the fourth response but before receiving the fifth request:
receiving, from the edge node that hosts the edge application, a seventh request for subscribing an MBMS user service change notification;
transmitting, to the edge node that hosts the edge application, a seventh response indicating whether the MBMS user service change notification is successfully subscribed; and
when the seventh response indicates that the MBMS user service change notification is successfully subscribed:
transmitting, to the edge node that hosts the edge application, an eighth request for notifying a change in the MBMS user service; and
receiving, from the edge node that hosts the edge application, an eighth response that acknowledges the eighth request.

82. The method of claim 81, wherein:
the seventh request comprises the identifier of the central application; and
the eighth request comprises at least one of the following: the identifier of a resource assigned to the MBMS user service, the service identifier assigned to the MBMS user service, and the service name of the MBMS user service.

83. The method of claim 73, further comprising forwarding a message from a user equipment (UE) via the edge application to the BM-SC for multicasting or broadcasting.

84. An edge node configured to host a Multimedia Broadcast/Multicast Service (MBMS) support service in an edge computing system, the edge node comprising:
a processor;
a memory storing instructions which, when executed by the processor, cause the edge node to:
receive, from an edge node that hosts an edge application, a fifth request for performing an MBMS session management procedure;
process the fifth request; and
transmit, to the edge node that hosts the edge application, a fifth response indicating whether the MBMS session management procedure was successfully performed, wherein the fifth response is at least partially based on a result of the processing.
